(19) United States
(12) Patent Application Publication
(10) Pub. No.: US 2024/0272916 A1
(43) Pub. Date: Aug. 15, 2024

(54) ADAPTIVE CONFIGURATION OF FINITE STATE MACHINES IN APPLICATIONS BASED ON USER RELATED CONDITIONS

(71) Applicant: Click Therapeutics, Inc., New York, NY (US)

(72) Inventors: Han Chiu, New York, NY (US); Ritesh Manchanda, New York, NY (US); Demetrius Johnson, New York, NY (US); Tyler Sargent, New York, NY (US); Heather Morris, New York, NY (US)

(73) Assignee: Click Therapeutics, Inc., New York, NY (US)

(21) Appl. No.: 18/631,501

(22) Filed: Apr. 10, 2024

Related U.S. Application Data
(63) Continuation of application No. PCT/US2022/046611, filed on Oct. 13, 2022.
(60) Provisional application No. 63/255,603, filed on Oct. 14, 2021.

(51) Int. Cl. G06F 9/448

(52) U.S. Cl. CPC G06F 9/4498

(57) ABSTRACT

Provided herein are systems and methods of configuring finite state machines (FSMs) for applications. A server may identify a configuration file for an application. The configuration file may define an FSM for a corresponding routine to address a condition. Each FSM may identify a plurality of states, each of which may specify an output for a respective routine. The output may identify graphical elements for a user interface of the application. Each FSM may identify a plurality of transitions, each of which specifies an event to be detected via the user interface. The event may correspond to an action to be performed via the application for the respective routine. The server may generate, using the configuration file, instructions defining the FSM. The server may provide the instructions generated from the configuration file to include in the application.

### CROSS REFERENCES TO RELATED APPLICATIONS

The present application is a continuation of International Application No. PCT/US2022/046611, titled “Adaptive Configuration of Finite State Machines in Applications Based on User Related Conditions,” filed Oct. 13, 2022, which claims priority to U.S. Provisional Patent Application No. 63,255/603, titled “Adaptive Configuration of Finite State Machines in Applications Based on User Related Conditions,” filed Oct. 14, 2021, each of which is incorporated herein by reference in their entireties.

### BACKGROUND

An application running on a computing device may provide a user interface containing various elements for display. The application may be configured to carry out a multitude of operations in response to a user interaction with an element of the user interface.

### SUMMARY

Aspects of the present disclosure are directed to systems and methods of configuring finite state machines (FSMs) for applications. At least one server may identify a configuration file for an application. The configuration file may include human-readable instructions defining a plurality of FSMs for a corresponding plurality of routines to address a condition of a user. Each of the plurality of FSMs may identify: (i) a plurality of states including at least a first state and a second state, each of which may specify an output to provide via the application; and (ii) a plurality of transitions, each of which may specify an event to be detected via the application to transition from the first state to the second state. The event may correspond to a user action to be performed via the application for the respective routine. The at least one server may generate, using the human-readable instructions of the configuration file, an intermediary instructions defining the plurality of FSMs. The at least one server may provide the intermediary instructions generated from the configuration file to the application to generate machine-readable instructions defining the plurality of FSMs to be selectively invoked by the application.

In some embodiments, each transition of the plurality of transitions in at least one FSM of the plurality of FSMs may specify the event to be detected via a user interface element of the application. The event may correspond to the user action to be performed for the respective routine. In some embodiments, at least one transition of the plurality of transition in a first FSM of the plurality of FSMs may specify the event to invoke a second FSM of the plurality of FSMs defined by the human-readable instructions of the configuration file. In some embodiments, at least one state of the plurality of states in at least one FSM of the plurality of FSMs may identify one or more user interface elements for presentation of the output via the application.

In some embodiments, the at least one server may receive, from a computing device, a script including the human-readable instructions generated using a development application. In some embodiments, the at least one server may use a transpiler to convert the human-readable instruction the intermediary instructions to be compiled by the application upon loading. In some embodiments, the at least one server may send, to a client device, the intermediary instructions to be loaded by the application installed on the client device

In some embodiments, the at least one server may select the intermediary instructions to provide to the application, in response to a request for routines to address the condition of the user of the application. In some embodiments, the at least one server may send content item for presentation via a user interface element of the application, responsive to the application invoking a first FSM of the plurality of FSMs upon detection of the event to transition from the first state to the second state. In some embodiments, the at least one server may receive, from the application on a client device, a record entry identifying the user action associated with the event detected via a user interface element of the application.

Aspects of the present disclosure are directed to systems and methods of handling finite state machines (FSMs) on applications. An application, upon execution on a client device, may load machine-readable instructions defining a plurality of FSMs for a corresponding plurality of routines to address a condition of the user. The application may identify the plurality of FSMs defined by the machine-readable instruction. Each FSM of the plurality of FSMs may identify (i) a respective first state of a plurality of states, each of the plurality of states specifying an output to provide via the application, and (ii) a plurality of transitions from the respective current state, each transition of the plurality of transitions specifying a respective event to be detected via application to transition a corresponding FSM from the first state to a second state. The respective event may correspond a user action to be performed via the application for the respective routine. The application may detect the user action performed via the application corresponding to the respective event specified by at least one of the plurality of transitions identified in a FSM of the plurality of FSMs. The application may update, responsive to the detection of the user action, the FSM to from the respective first state to the second state to provide the output provided by the second state.

In some embodiments, the application may generate the machine-readable instructions by compiling intermediary instructions defining the plurality of FSMs received from a server. In some embodiments, the application may identify the machine-readable instructions for the corresponding plurality of routines to load based on the condition of the user to be addressed.

In some embodiments, the application may replace second machine-readable instructions with the machine-readable instructions, responsive to receiving an configuration update including the machine-readable instructions to address the condition of the user. In some embodiments, the application may transmit, to a server, a record entry identifying the user action associated with the event detected via a user interface element of the application

In some embodiments, the application may monitor, using an event bus, an invocation of the FSM in response to the user action corresponding to the respective event specified by the at least one of the plurality of transitions of the respective current state. In some embodiments, the application may retrieve, from a server, a content item for presentation via a user interface element of the application in accordance with the output specified by the second state of the FSM. In some embodiments, the application may present one or more user interface elements on the application in accordance with the output specified by the second state of the FSM.

In some embodiments, each transition of the plurality of transitions in at least one FSM of the plurality of FSMs may specify the event to be detected via a user interface element of the application. The event may correspond to the user action to be performed for the respective routine. In some embodiments, at least one transition of the plurality of transition in a first FSM of the plurality of FSMs may specify the event to invoke a second FSM of the plurality of FSMs defined by the machine-readable instructions of the configuration file.

Aspects of the present disclosure are directed to systems and methods of configuring finite state machines (FSMs) for applications. At least one server may identify a configuration file for an application. The configuration file may define a plurality of FSMs for a corresponding plurality of routines to address a condition. Each of the plurality of FSMs may identify a plurality of states including at least a first state and a second state, each of which specifies an output for a respective routine of the plurality of routines. The output may identify one or more graphical elements for a user interface of the application. Each of the plurality of FSMs may identify a plurality of transitions, each of which specifies an event to be detected via the user interface of the application to move from the first state to the second state. The event may correspond to an action to be performed via the application for the respective routine. The at least one server may generate, using the configuration file, machine-readable instructions defining the plurality of FSMs to be selectively invoked by the application. The at least one server may provide the machine-readable instructions generated from the configuration file to include in the application.

In some embodiments, the at least one server may receive, for storage in a log record database, a record entry associated with an interaction detected on the user interface of the application matching an action corresponding to the event specified by at least one transition of the plurality of transitions. In some embodiments, the at least one server may provide, responsive to a request for content, a content item to a client device to present as one of the one or more graphical elements for the user interface of the application.

Aspects of the present disclosure are directed to systems and methods of handling finite state machines (FSMs) on applications. A client device may identify a plurality of FSMs defined by machine-readable instructions for an application. The plurality of FSMs may be for a corresponding plurality of routines to address a condition. Each of the plurality of FSMs may identify a plurality of states including at least a first state and a second state, each of which specifies an output for a respective routine of the plurality of routines. The output may identify one or more graphical elements for a user interface of the application. Each of the plurality of FSMs may identify a plurality of transitions, each of which specifies an event to be detected via the user interface of the application to move from the first state to the second state. The event may correspond to an action to be performed via the application for the respective routine. The client device may determine that an interaction detected on the user interface of the application matches the action corresponding to the event specified by at least one transition of a FSM of the plurality of FSMs. The client device may invoke, responsive to the determination, the FSM to update the current state of the FSM to a next state and to modify the user interface to present the one or more graphical elements identified in the output for the next state.

In some embodiments, the client device may maintain the current state of each FSM in the plurality of FSMs for the application. The current state may be associated with one or more of the plurality of transitions. In some embodiments, the client device may send, for storage in a log record database, a record entry associated the interaction detected on the user interface of the application matching the action corresponding to the event specified by the at least one transition.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 depicts a block diagram of an architecture for an system for managing plugins in accordance with an illustrative embodiment;

FIG. 2 depicts a screenshot of a user interface for defining a finite state machine (FSM) to be used in the system for managing plugins in accordance with an illustrative embodiment;

FIG. 3 depicts a block diagram of an architecture for an event bus in the system for managing plugin in accordance with an illustrative embodiment;

FIG. 4 depicts a block diagram of an event bus interfacing with multiple finite state machines in the system for managing plugins in accordance with an illustrative embodiment;

FIG. 5 depicts a flow diagram of a process for unlocking a skill in the system for managing plugins in accordance with an illustrative embodiment;

FIG. 6 depicts a block diagram of a sequence of events and states in the event bus of the system for managing plugins in accordance with an illustrative embodiment;

FIG. 7 depicts a block diagram of a system for managing layouts for plugins in accordance with an illustrative embodiment;

FIG. 8 depicts a block diagram of a platform in the system for managing layouts for plugins in accordance with an illustrative embodiment;

FIG. 9 depicts a block diagram of trees for defining rendering of user interface in the system for managing layouts for plugins in accordance with an illustrative embodiment;

FIG. 10 depicts a block diagram of an example user interface used by the system for managing layouts for plugins in accordance with an illustrative embodiment;

FIG. 11 depicts a flow diagram of a process for parsing configurations in the system for managing layouts in plugins in accordance with an illustrative embodiment;

FIG. 12 depicts a block diagram of a configuration tree generated by the system for managing layouts for plugins in accordance with an illustrative embodiment;

FIG. 13 depicts a block of an example tree and navigation screens generated by the system for managing layouts for plugins in accordance with an illustrative embodiment;

FIG. 14 depicts a block diagram of theme configuration used in the system for managing layouts for plugins in accordance with an illustrative embodiment;

FIG. 15 depicts a flow diagram of a process for merging themes according to priority in the system for managing layouts for plugins in accordance with an illustrative embodiment;

FIG. 16 depicts a block diagram of a system for providing finite state machines (FSMs) in applications in accordance with an illustrative embodiment;

FIG. 17A depicts a block diagram of a process for generating instructions in the system for providing finite state machines (FSMs) in applications in accordance with an illustrative embodiment;

FIG. 17B depicts a block diagram of a process for handling finite state machines (FSMs) in the system for providing finite state machines (FSMs) in applications in accordance with an illustrative embodiment;

FIG. 17C depicts a block diagram of a process for modifying a user interface in the system for providing finite state machines in applications in accordance with an illustrative embodiment;

FIG. 18A depicts a flow diagram of a method of configuring finite state machines (FSMs) on applications in accordance with an illustrative embodiment;

FIG. 18B depicts a flow diagram of a method of handling finite state machines (FSMs) on applications in accordance with an illustrative embodiment; and

FIG. 19 is a block diagram of a server system and a client computer system in accordance with an illustrative embodiment.

### DETAILED DESCRIPTION

For purposes of reading the description of the various embodiments below, the following enumeration of the sections of the specification and their respective contents may be helpful:

Section A describes a frontend platform and architecture for a behavior engine for configuring applications to run finite state machines (FSMs);

Section B describes a frontend platform and architecture for a layout engine for defining user interfaces of applications in accordance with the finite state machines (FSMs);

Section C describes embodiments of systems and methods of configuring and handling finite state machines on finite state machines (FSMs); and

Section D describes a network and computing environment which may be useful for practicing embodiments described herein.

### A. Platform & Architecture for Behavioral Engine

The layout engine may be configured to build out screens and content, but may not handle anything more than a simple sequence of screens. This may not be sufficient for supporting a rich content platform. For example, in a flow, if there is to be a separate logic branch based on user input, then the layout engine may not be designed to handle this. Another scenario may be if the application is in the middle of a flow and receives a push notification, the determination as to whether to interrupt the flow may not be well defined.

To address these challenges, the logic for running the application may be defined in a domain-specific language, such that clinical operations can be customized and not hard-wired into the application. This may provide an ability to control the functionalities of the application especially when clinical operations have control over not only the content but the logic in which the content is presented.

### 1. Context

A layout engine may support user interface (UI) design and placement. This may allow non-developers (e.g., clinicians) to build out content for various clinical operations. The layout engine may support both layouts of components on a screen but also supports navigation stacks (e.g., tab, stacks, and modals). The layout engine can be limited to supporting linear content, for example, a sequence of screens where next and back are the only options without any augmentation. The operations of an application, however, may include complex, branching decisions, interruptions to flows, and user interactions. These complexities may entail a change in the flow of screens, error states, and application programming interface (API) calls to change the presentation of the user interface.

To solve these problems, a behavioral engine defining customized logic, state machine, or behavioral tree may be added with the layout engine to work side by side. The behavioral engine may augment the layout engine to be more capable than supporting static linear sequences, such as dynamic flows with branching and error handling, among others. In short, a behavioral engine may support interactions, logic, and state management, among others. Where the layout engine is focused on the presentation, the behavior engine may configure interactions and states for the application.

The behavioral engine can be configurable by clinical operations. For example, the content and therapy is all about making intelligent decisions using past and present data. Given a user's data, what the therapeutic journey is for the user may be configured and customized. The behavioral engine may also help with internal development. Since much of state management and reasoning is the cause of defects or bugs, defining the journey via the behavioral engine, may improve the quality of the application.

### 2. Objective

If the application is configurable by clinical operations, the application may have the ability to provide more varied, interactive content. For example, if the behavioral engine is configured to keep track of the day of treatment and the user has not completed any lessons, the application may be configured by the behavior engine to display an additional screen of exhortation.

The capabilities may be defined in a configuration file to specify the layout and logic for the application. The content assets may reside on a content management system (CMS). Relying on the CMS, the configuration file may defined to provide the content (including the look and feel), flow, and behavior for the application. The application may also have starting logic as well for various operations such as boot up sequences, flow, simple deterministic operations.

The application may also be configured to carry out game mechanics logic. The behavioral engine and the configuration file may be used to carry out game mechanics and accompanying artificial intelligence (AI). Under this schema, the therapies may be much more interactive. With game mechanics, the therapies provided by the application may simulate a session with a human therapist. In such a session, a therapist may dynamically customize strategies and content to address the conditions of a patient. In addition, feedback on the patient from the treatment may be incorporated into the session.

The training session as laid out in the configuration may become an interactive game in which the user is engaged and the application adaptively interacts with the user. The ability to address the conditions of the patient may improve with the application learning how to solve or learn treatment strategies. The behavioral engine may test the patient and evaluate what is the best next step in the treatment.

Using data on studies regarding the rewiring of the human brain, the configuration file may be designed to leverage the data to identify which parts of the brain are not working properly for a given disorder. The behavioral engine may be equipped with a tool box of scientifically proven exercises for the given disorder and what part of the brain needs is to be targeted. The behavior engine can be used to customize the treatment per person and target the relevant portion of the brain.

### 3. Specifications for the Behavioral Engine

The behavior engine may be customizable using a configuration file and the content management system (CMS), not hard-wired in the application code. The configuration file may allow non-developers to define logic. The behavior engine may also be serializable. In the course of treatment, a user may quit the application, but the application may continue to keep track of the progress. The behavior engine may support temporal values that may not be serialized. For example, a flow may specify that state is to be kept track only for the life of the flow. The value of a text field in a user interface may be used in the next step. The states may not be saved or serialized between sessions.

The behavior engine may be composable with building blocks. The application may lack one massive engine to handle all the various functionalities of the application. For example, in React or Redux applications, all the application logic may be in one place (e.g., Redux), and the application may become error-prone and difficult to manage. The behavioral engine may be used to reduce complexity. A composable engine can break the problem up into sub-problems. Each lesson may have a separate configuration. A shared state may be supported, and this can be done by one lesson exposing a state that a different lesson can consume.

For each composable unit, the behavioral engine may support multiple instances of the flow. For example, on day 20 the lesson (e.g., deep breathing) may have a state so that on day 21 (e.g., deep breathing) does not conflict. The data may be shared but isolation may also be supported. The behavior state may be parsed for analytics. For example, the backend may capture both state, history, and current status of the behavior, so that the analytics can determine what state the user is in, has been in, and the details of that state, among others. The behavioral engine can handle conflict resolution, so if two devices are out of sync, these devices may become synced to support a new state.

The configuration may be independent of any application and reusable. Sharing the lessons, login flows, and other information may easily be shared between different applications without copy or pasting. In this manner, a flow may be displayed and may be independent of the behavior engine. For example, a behavior may be just a simple wizard going step by step. The lesson defined by the configuration file may track progress. The behavior can drive any layout engine screen. Thus, ten flows with different content may rely on the same behavior definitions.

The behavior engine may accept and handle external events not only from the layout engine (e.g., user interactions) but also from external events like push notifications, backend API calls, and timers, among others. Migration state from one version to another may be supported (e.g., version 1 to version 3). The new behavior flows may keep working even if another started on a different version (e.g., version 1). The behavior engine may rely on triggers and use external code. For example, the behavior engine may make API calls to retrieve data, or trigger local notifications.

### 4. Architecture for Behavioral Engine

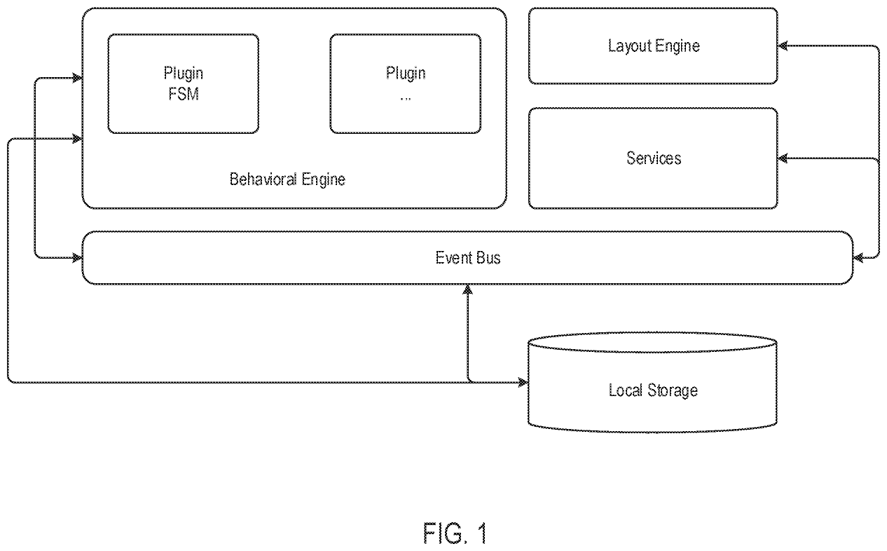

Referring now to FIG. 1, depicted is a block diagram of an architecture for a system for managing plugins. The architecture may be a plugin-based and may be extendable over time. The behavioral engine may communicate to the rest of the application by passing messages. The passage of the messages may be handled via a reactive stream or an event bus. The behavioral engine may have direct access to local storage so that the engine instances (e.g., an instance of a finite state machine (FSM)) may be serialized and deserialized.

Event Bus may be the primary way the behavioral engine is to communicate with any other part of the system, except for a local storage. This may be because each plugin may be responsible for code for serialization and deserialization. Local Storage may be the way the application stores data locally. The layout Engine may be responsible for the presentation layer. The behavioral engine may be aware of all user interactions and may change the presentation as the state changes.

Services may perform activities for the application. An application may have logic outside of the presentation layer, such as receiving push notifications, scheduling reminders, handling errors, and making backend API calls, among others. The behavioral engine may have a way to listen to their events or trigger a service to perform an activity. This notification and trigger may be done over the event bus.

For example, the application may have a FSM managing the login or signup flow. Within the flow, the FSM may specify branching, API calls, maintenance of tokens, handle errors, control flow, and binding states, among others. In this example, the configuration file for the FSM may define a new behavior “launch” and its type is a “FSM”. This may signal to the behavioral engine to pass the configuration to the FSM plugin and to indicate that the plugin is responsible to create a behavior that is to be instantiated later. The configuration file may also specify that the state machine has a starting state of “boot.” Then, the configuration file may identify two parallel states that are to be satisfied before going to the final state.

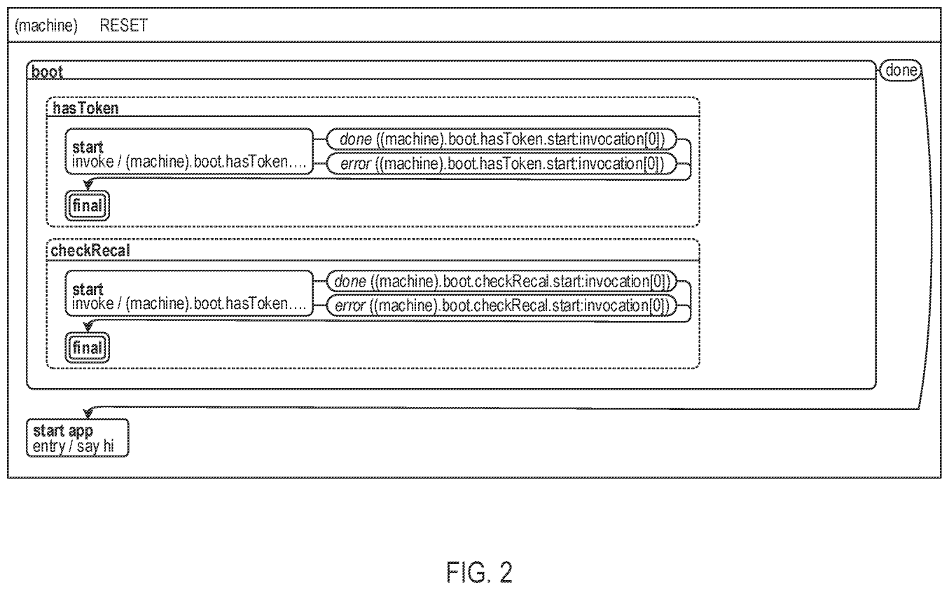

Continuing with the example, the two steps may make calls to the backend to (1) verify that the active sign in a token is valid; and (2) make a call to the backend to check whether there is a recall or message to show the user. This call may be about force upgrades and critical messages, among others. This may be a service or external operation that the FSM can call on, and can define any kind of service. The operation may be an API call, such as prompting the user for input including additional information such as URL and timeout, among others. Additionally, the FSM may cover all states, such as onDone or onError. The complete definition may ensure coverage of all the states. For example, as depicted in FIG. 2, a visual editor may be used to build out the states and transitions for the FSM.

The behavior engine may have a plugin architecture. The FSM plugin may be one of many plugins that can be configurable. Returning to the above example, the FSM can be built with configuration and visualization of all the states. The FSM may have an input and a few outputs. The input may be a trigger that requests the FSM to transition to a new state. This request can include a payload or data. The outputs may be triggered as the FSM changes the state. The FSM may monitor for external events triggered by the user or another process. The FSM may determine a result of the input. The FSM may output that next step (or the state) with the payload.

The glue between the FSM and another part of the application may be the event bus. In some embodiments, the event bus may be a reactive stream, permitting other components in the application listen and publish on the bus. The reactive stream may support operators, such as debouncing, combine, maps, and scheduler, among others. Finally, there may be two listeners: the layout engine and analytics. Both may be bidirectional on the bus to receive and send messages. For example, regarding launching the application using the behavioral engine, the FSM may hide the splash screen and show the login/signup flow or the signed-in state. This may be performed by adding an action or invoke to the “start app” state such that that the FSM can signal the layout engine to navigate to a new screen/flow. With the instruction to display a new screen, the FSM can provide a payload. This payload can include a show screen, or may include details such as a tab navigator and auto-select the third tab. When the application is done with the boot, the FSM in the application may state “start app,” when that state is entered, and may check three conditions, such as showMessage, gotoHome, and unauthenticated. In turn, the application may automatically select the correct next state in the FSM using the “cond:” (conditional) logic. The FSM may perform the action layout.showModal or layout.showFlow. This may publish a payload onto the bus.

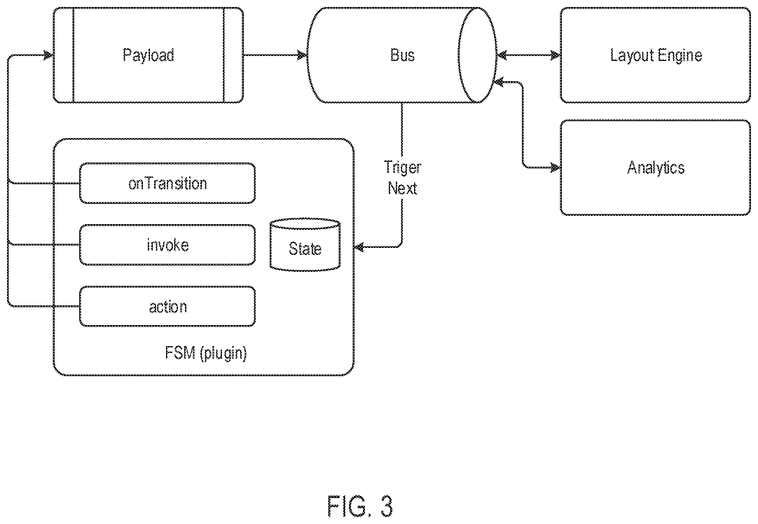

Referring now to FIG. 3, depicted is a block diagram of an architecture for an event bus in the system for managing plugin. As depicted, the layout engine may listen for events. So the FSM payload of showModal or showFlow may be received. This payload may inform the layout engine what to do in terms of displaying a screen and or flow. Additional metadata in the payload in some cases may be used to send additional details to an external source. For example, when supporting deep linking, the FSM may identify a user into the middle of a flow. The history may be reconstituted so the back button may work correctly. The behavior engine and layout engine may interface with one another to control the flow of screens and branching.

### a. State

The behavioral engine can be used to define the interactive logic to power the user's journey in the application using the state. The state may correspond to the current state of the FSM, and may also include variables, metadata, and history, among others. The behavioral engine may support this and may broadcast changes so any component can be notified of state changes with the internal details.

The FSM may handle the internal variables, metadata, and history and may also provide a window into its internal working. This composable isolated box (encapsulated) may make it possible to have the UI and other FSM away from some kind of state. The application may not console or understand the logic, but may emit events using the FSM to process the events. In some embodiments, Redux may be used to configure or define the FSMs. Redux may not be configurable via a configuration file. How the FSM processes events based on its current state may not change using Redux. Redux may have a global state and may not have instances of itself.

The FSM can store both state and metadata around transitions. But the application may keep track of states outside the behavioral engine using the FSMs. The data may be stored in the FSM and behavioral engine or can also be saved or shared externally to the FSM. As such, the application can use hooks, Redux, and MobX, among others. The UI may bind to the FSM state, and may use the bus.

The behavioral engine may support serializing or deserializing instances of a plugin (FSM). This support may allow to have multiple instances of the same behavior (FSM). For example, if flow may be checked on a day-to-day basis, each day may be an instance and may have its state values stored on a local storage. The state in addition to all the raw state data, which current state the FSM is in, and metadata, among others, may be human-readable. The backend may be able to read and process the data.

One benefit of having the behavioral engine supporting instances may include composable building blocks. Each instance may be isolated and atomic, and can have a private state and keep track of the current state. The instances may have the ability to talk, share, and spin up temporary FSM, among others. Sub modules sending messages to one another may make the system more understandable and composable. These building blocks may be connected via the bus.

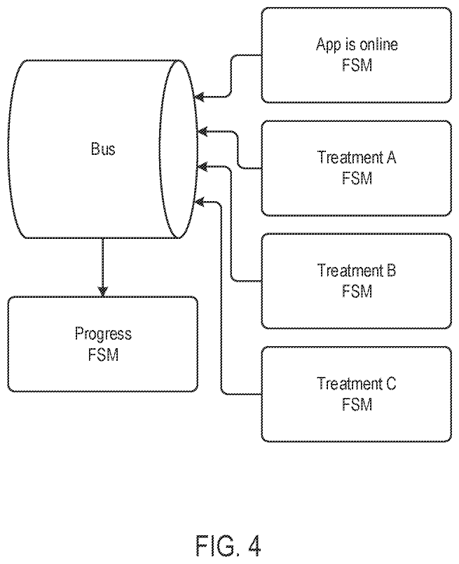

Referring now to FIG. 4, depicted is a block diagram of an event bus interfacing with multiple finite state machines in the system for managing plugins. When the FSM changes state, the FSM may broadcast the change to the application. Reactive streams may be used to tap into various functions, such as stream, filter, reshape, and debounce, among others. This may let the user interface receive changes to any instance of a FSM, and FSM may listen to other FSM. For example, the UI may show progress of a treatment, but each treatment may have its own FSM. So the treatment FSM may broadcast “the patients score is 80 and only 3/6 steps completed” so the progress FSM may get this to update an animation on the home screen.

One benefit of the reactive stream may be that if an FSM is broadcasting state changes, a consuming component of the stream can drop in a transformer along the path. As such, an FSM that sends data out may not talk to an FSM that is not be designed to handle the message. Compared to FSMs, Redux may lack additional power and benefits that come with reactive streams and state machines. On the other hand, an FSM can be configured without any code or with little code, making a graph more explicit. For example, in Redux, an action may be dispatched and the reducer may update the global state. The Redux may not be able to have the current state process an action differently, and all actions may be handled the same way. A naive example may be if an action “BACK BUTTON” specified in an FSM and the current state was in login state versus another step in a flow. The FSM may identify the login state and go back one step in the flow. In Redux to support this, a more global state may be created to address the problem of exploding states and complex mixed states. This may lead to bugs and unpredictable behaviors. That is why explicit states as defined in FSMs may be safer and more reliable.

For example, a behavioral engine processes data internal and external to perform a task. If the application gets to a sign-in screen and the last logged-in user's email address is known, the FSM may be used to determine what is to be shown in the UI. The FSM may identify that a user has clicked the login button or forgot password button. The FSM may also handle the scenario including error states for this screen, such as lacking access to cellular network or Wi-Fi.

In another example, an FSM may be used to implement a radio. The FSM can tune into a station, and this station may broadcast news after the user pushed the back button. The user may have pressed the button named “Login.” The FSM may display the screen, “Welcome back!” or the user is typing in the email or password field. Multiple FSM can be tuned into this radio station. But in this example, the login FSM may wait until it has heard the message, “The user is viewing the screen Welcome back!” Then the FSM may transition into the active state. So when the FSM hears the message “user pushed the back button,” the FSM may trigger the screen to be popped and may go into the inactive state. Listening to events may be the way the FSM perceives the outside world. Then the FSM can have its internal state. This may be private in the sense the FSM is the only one that can change things. This state can be serialized/deserialized. The internal state may be bound to the UI, and the FSM can drive some UI.

FSM may have other advantages over Redux. At any given point, an FSM may identify potential state changes. This meta-information may be used to setup the UI. For example, buttons can be enabled or disabled based on the list of next valid states for the FSM. In the example above, the FSM may transition into the state of “validated login” when the FSM determines that the email and password fields are valid. As such, the button may remain greyed out. Instead of using a state value to drive these changes, the next state list may be used to render the button state correctly in accordance with the FSM definition.

FSM can also support side effects with feedback. An asynchronous request may be invoked, and the FSM internally may wrap the request into three new states, such that the FSM can direct the application to perform a task. The FSM may also change logic based on failure or reject states. In Redux, this may be difficult to implement. In addition, FSM may be a state chart, and can have history and metadata around transitions, such that the FSM may hold a snapshot in time. The FSM may keep track of its current state, and can have details around the transitions to the current state. This is useful for handling errors. For example, multiple reasons can cause an FSM to change into an error state, but with this information, why the FSM was put into that state may be deduced. This information may be tracked as a state variable, and also as the history.

The way the FSM can trigger side effects in the application may be when the FSM transitions into a new state, trigger an action, or change state, and this may be a queue for the UI. The FSM may be queried on what state the FSM is in, what are the possible next states, and view initial values, among others. This may be powerful because the UI can watch for changes in the state, or be explicitly requested to perform a task. FSM can drive actions and state, and express the actions and states via the UI.

### b. Binding

The FSM and may be wired up to the event bus, and this can be a different plugin in the behavioral engine and the layout engine. The engines may also have binding syntax or rules. For example, the UI in the layout engine may specify that the UI is to be bounded to a Login FSM. Then the layout engine may direct that the email address field is to be bound to the FSM ref value. This may mean if the FSM email value is “bob,” the email address field may default to the value “bob.” The enabled or disabled state of the button may be determined by the FSM's current state.

When the button is pressed the layout engine may fire a message on the event bus. The FSM may be wired up to listen for that press and may trigger a state change. This state change may then trigger an API call. The result of the API call may trigger the next state and so on. The FSM may execute a sequence of events defined by the behavioral engine and at certain points, the FSM may instruct the UI to change screens, navigation, values on the screen, or trigger an external service to perform work, among others.

In this manner, the layout engine may send a message on the bus that instructs the FSM to change state. The external code can do the same. For example, if the application detects the client device has gone into airplane mode or no longer is connected to the Wi-Fi, the application can broadcast the event, and the FSM can use a listener for the event to handle or to show a flash message.

### c. Event Bus

A reactive stream may be used so that any part of the application can broadcast and consume events via stream processing. This may be similar to having an evented architecture. One benefit to this is parts of the application may be decoupled and isolated from one another. If there are over 100 FSMs, different applications can use a few of the FSMs as they are fully encapsulated. The state, UI, and theme may be independent of the application, and can shared or communicated to other parts of the application via the bus.

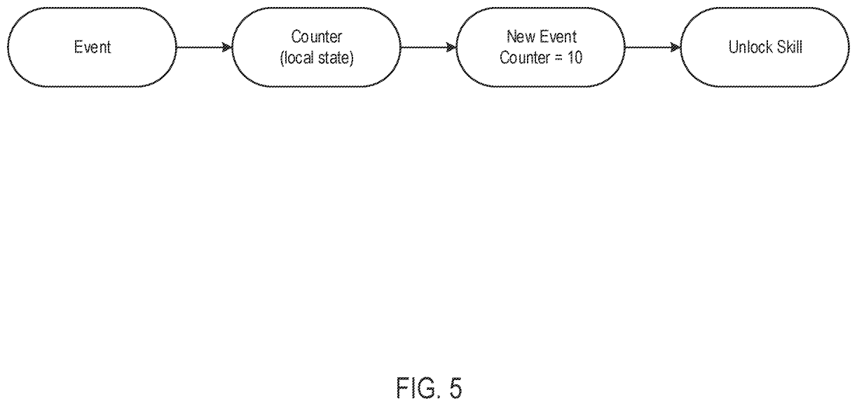

Referring now to FIG. 5, depicted is a flow diagram of a process for unlocking a skill in the system for managing plugins. In the example depicted, the process may be for a “try it, cache it, change it” plugin. This FSM may be used by two different applications. In one of the applications, there may be a progress leader board and the other application may prompt someone to graduate the lesson specified by the FSM before unlocking a new skill. Both these use cases may be supported by using the bus.

Using events to represent the state, the FSM may emit change events. These events may be public to any part of the application, so any component can subscribe and transform that information into useful events. In the case of progress, the application may mark the user has completed the task, and may update the user status, rank, and other information on a screen. For cases where access to other skills is dependent on mastery of one lesson, the application may have a transformer that may keep track of the number of completed events, and when the lesson is completed a set number of times (e.g., 10 as depicted), may make new skills available.

Events may be a more expressive form of state. For example, when a lesson module indicates that a user started the lesson, the user may have indicated as “having negative thoughts”, selecting the strategy of “writing 10 positive things down”, then completed the lesson, and finally rated the session as “somewhat helpful”. The metadata may be leveraged more so than the state in this regard. In this example, if a state representation of the same data is considered (not using the events), the state may correspond to three conditions: (1) “has completed lesson,” (2) “picked writing 10 positive things down,” and (3) “session somewhat helpful.”

The state in this scenario may not be helpful, when a different part of the application is to unlock a skill after 10 completed sessions. When that happens may be undefined, and/or a counter may be incorporated into the state. The lesson may be encapsulated and shared between different applications. As such, adding various states to solve a one-off problem for a single application may not be scalable. But using a bus, the application can listen to the event “completed the lesson” and maintain its counter. When the counter reaches 10, the application may fire a new event that the application may use.

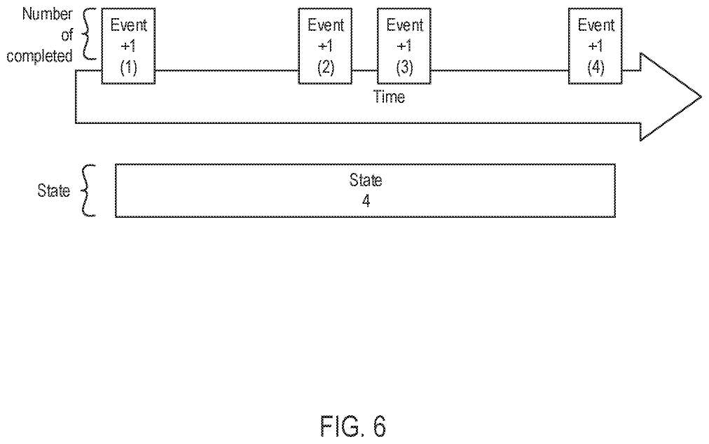

Referring now to FIG. 6, depicted is a block diagram of a sequence of events and states in the event bus of the system for managing plugins. Seeing the history of events, with all the delta changes, a set of synthetic states may be constructed, allowing the application to react in real-time. The state may correspond to snapshot in time, but the FSM may not lose the information to look at the world as an event. Using history, various snapshots may be built. The bus may also open the possibilities up to new types of modules. For example, the application may carry out a voice analyzer or a machine learning (ML) model around predicting depression. With an event bus, the application may use the event bus to broadcast information. The information may be taken and features may be created to become inputs to the ML or voice analyzer module. Then in return, the corresponding FSMs may emit the result and analysis of the input. The FSM may take that information as input and change the UI. This is all in an insulated way so that different applications may act differently, but the same ML may be the same in all applications. The bus creates much better composability and isolation.

### 5. A/B Testing and Analytics

Event bus can also carry out A/B tests. Different layouts or behaviors may also be used for the A/B tests. The event bus can swap out how messages are sent. For example, the application may use two layouts for “A” and for “B” and use the event bus to connect an FSM to the “A” version of 20% of the users. From the deployment point of view, the streams may be connected differently for the “B” version.

Analytics may also be another application where event stream is useful. If a user consented to share information, then the events detected via the application can be provided in real-time. This may create an analytics stream that may be plugged into a future data pool. Additionally, the format of the data may be in a more in depth format than state snapshots. For example, the application may be synchronizing the state of an FSM to the backend. A database may store and maintain user progress (e.g., completion of various tasks). The database may be queried for whether users completed a given task in the first week vs next week. When only the snapshot is used, the information and context around the data may be lost. The FSM and reactive streams may be normalizing this stream so that various information may be kept track.

### 6. Mechanics

The behavior engine may have various modules that can control logic and are bound to the UI. The modules can state and emit events, and may be isolated, but also composable. The modules may be used to implement game-like mechanisms. By learning new skills in a game, the user may make progress in the game environment. Behavior change can also leverage game mechanics. For example, adaptive cognitive training, an approach to enhancing aspects of cognition, may involve repetitive training where task difficulty is continuously adjusted based on performance. These training exercises may be typically provided for a fixed amount of time or dose (or in accordance with any combination of any number of parameters) across participants and leverage rewards as a way to encourage adherence, which tends to be poor in the real-world given the training demands.

This example also may illustrate several opportunities that are afforded by taking a modular approach. One may be targeted training: using data collection from a variety of sources, which exercises to provide to a user may be selected. Another may be decreasing training demand: continuous data collection during training can allow for adjustments to the amount of training or the dose to administer to participants, which may help adherence. Another may be Incentive alignment: the optimal training pattern or environment for a user as well as the type and frequency of reward that is optimal for training may be determined.

The human brain may have both physical and perceptual challenges that impact the overall health of an individual. Starting with FSM, a dynamic path through a list of exercises using real-time feedback may be created, pulling in information and events from other modules and knowledge. A model (in the form of FSM) may be defined to construct and model status of the human brain, such as happy, sad, trigger, and other, among others. All the information collected from the lessons may be used to figure out in the status of the brain.

For example, the FSM may start by sending a notification four times a day to the prompt the user a few questions. Each event may be designed to determine whether the user experiences cravings. The goal of the FSM in this state may be to figure out if there is a pattern to the cravings (e.g., occurring around 3 pm). Then, the FSM may change the state after determining the time, and stops the notification and may enter a state to send a notification at the determined time. The goal of the FSM in this state may be to figure out what is the root cause of the craving, such that the FSM can target a much better treatment plan. Once the FSM moves into the treatment plan state, the FSM may track success from other parts of the application like the daily check-ins. The FSM may also revert the state to a new state if no progress is determined to have been made.

The goal of the FSM may be to match the understanding of the state of mind. From there, the FSM can target the optimal treatment option. As a human therapist asks questions to inform them of what state the patient is in, the FSM can mimic this. The application may run multiple FSMs to address the unique characteristics of the user. The application may also have content, and daily lessons, among others.

The application may collect information for analysis from running a hypothesis model (FSM) of how the patients' brains react in relation to treatment. The FSM and all the raw data may be emitted for additional analysis. The FSM and UI may be configurable and even deployable. The FSM may also just the starting point, and over time a new logic engine may be deployed making the mechanics or AI better.

### B. Platform & Architecture for Layout Engine

An architecture may separate the therapy from the delivery of that treatment. The architecture may be used to create a platform and engine to take configuration in the form of a treatment flow as defined in a content management system (CMS) and a markup file (e.g., YAML or XML) to define a treatment on a mobile device.

### 1. Overview

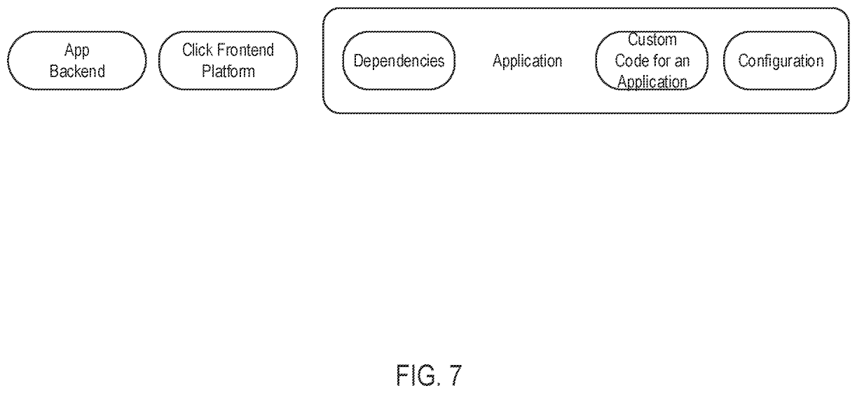

Referring now to FIG. 7, depicted is a block diagram of a system for managing layouts for plugins. The system may include the application, platform, backend, and infrastructure. The application may include React Native, Application specific code, and the configuration that defines the therapy and appearance. The platform may convert therapeutic content into a running application. This may take shared components, configuration, and behavior trees and executes them on a device that a patient can interact with. The backend may provide external storage and services needed for the application. The infrastructure may be used to help the development cycle and ensure quality and regulatory compliance. This may include a repository, CI/CD, Changelogs, and server setup, among others.

### 2. Application

The application may be a container that holds the configuration files that define the therapeutic. In addition, custom code unique for a specific application can also be a part of this bundle. This specific application code may not be a part of the platform, but can be included and managed by the platform. This may be to ensure a clean separation between all parts of the application, including the therapeutic, custom code, and the platform, among others. The application may reside within a repository and may be scoped to its own directory structure. The repository may help with the separation and code reuse from the platform. By having the platform code outside of each application code base, separation can be ensured, but the structure may also ensure that it is not blocked from building custom applications relying on specific native code or having to be delivered to an application store.

### 3. Layout and Activation Architecture

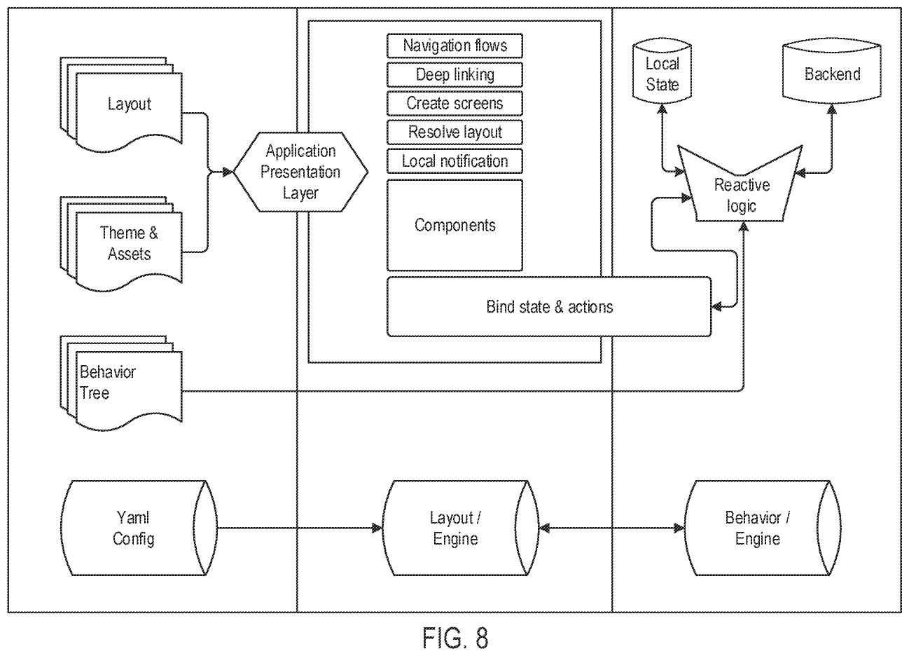

Referring now to FIG. 8, depicted is a block diagram of a platform in the system for managing layouts for plugins. As depicted, the platform may include a configuration file (e.g., YAML), Layout Engine, and Behavior Engine. The configuration file may be configuration data used by both the layout and behavior engine. The architecture can be broken up into two active layers: (1) the layout engine and (2) the behavior engine. The layout engine may take human readable configuration and turn the script into UI. The behavior engine may control the display of the UI. The configuration in human-readable format may allow developers with little coding knowledge to readily write and provide scripts for configuring the UI and the behavior thereof.

Starting with the layout engine, the engine may obtain its configuration from human readable YAML files, not from JavaScript (JSX) code. The motivation behind this configuration may be to permit having clinical product, design, and operations define the screens without heavy reliance on development. The CMS may manage this configuration, not via YAML files. Additionally, the configuration may be modular so that any content, therapeutic activities, flows, behavior can easily be shared between applications.

The behavior engine may include definitions for which screen in a flow should be displayed and in what order; the current state and values of components; handling events such as errors, reminders, sync events, and deep linking, among others; and managing the place of the current user in a therapeutic activity. The motivation may be to capture clinical intervention strategies and the application may dynamically select the correct strategies for the patients based on their history and state. This may also be defined in configuration not code.

### a. Layout Engine

The layout engine may handle the placement and style of components, manage the content (e.g., text, image, and other objects), control the navigation, flash messages, keyboard avoidance, modal and overlays, deep linking, headers, and tabs, among others. This may correspond to the presentation layer. The layout engine may leverage components that may be developed in code, but are configurable by the layout engine.

Components may be encapsulated and atomically impactful to building of the UI. The layout engine may not do the work for nesting multiple components and managing the state to build components that a code component may do by itself. The layout engine may not be intended to build components out of components. The components may be meant for a non-developers and may permit drag and drop, not meant for composition that a developer does in code. The layout engine may be designed to consider clinical product, design, and operations to interaction with the layout engine. Flows or common groups may be defined in the CMS, and low level React-like components may be developed using code. For example, developers can use the repository, share components to build nice building blocks that a CMS user may then use to build content groupings.

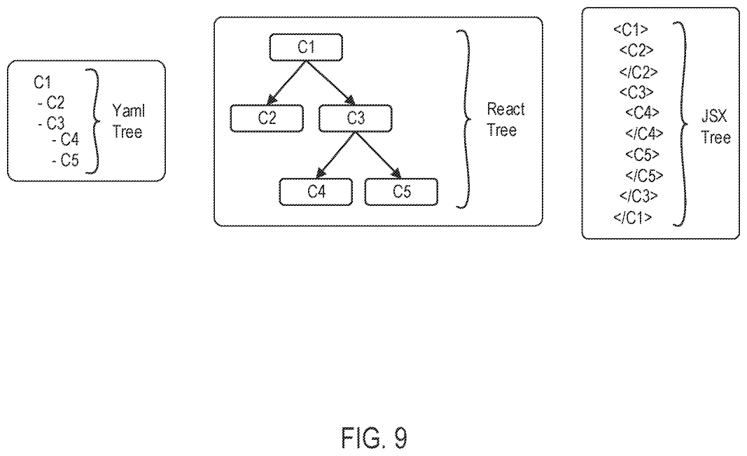

Referring now to FIG. 9, depicted is a block diagram of trees for defining rendering of user interface in the system for managing layouts for plugins. The layout engine may be configured with YAML. YAML may permit a 1-to-1 mapping of a tree structure similar to a react component tree. YAML may represent any tree that a React Native tree can. YAML may be more human readable than JSX (XML) or JSON (code). The hierarchy of nodes in the tree may correspond to indenting in the YAML file. A react component YAML can also have properties for each node. This may allow each node to be customized with additional properties. Additionally, the YAML file may be relatively terse and human readable.

Given the nature of mobile applications and limited screen space, most screens can be characterized in a few different ways. A list of components top to bottom, grid of tiles, single screen with minimal content, tabs, etc. For example, components may be stacked on top of each other and in some cases using a grid in a stack of items. The button may be almost always at the bottom with a header. This may be defined using a YAML file. In another example, with a splash screen example, there may be four components in a stack. Each component may have properties. The layout engine may inject default styles so stacking items without reliance on flex box (e.g., React layout syntax). Themes that help the layout engine determine the optimal padding, colors, and font size, among others may be supported. The layout engine may also enforce rules so that any screen can have keyboard aware layouts with auto scroll, flash message, and modals, among others. This may be because the layout engine defines a consistent approach to how each screen is built up. There may be no need to know how each component is wired up to keyboard-aware layouts, as the layout engine can wrap and handle all the logic.

Usability and accessibility specifications may define the inner workings of the layout engine. In native react code, each screen may be defined as a new component. For example, an application with 100 screens may in turn have 100 different layouts, even though a small group of components may be used to form larger components. The complexity of keeping track of how small changes in a single component may impact hundreds of different layouts is difficult. The definitions provided by the layout engine may be akin to having a single screen. The layout engine may handle that placement, making sure each component works with features like keyboard aware layouts. The layout engine may also make the application have a more consistent look and feel.

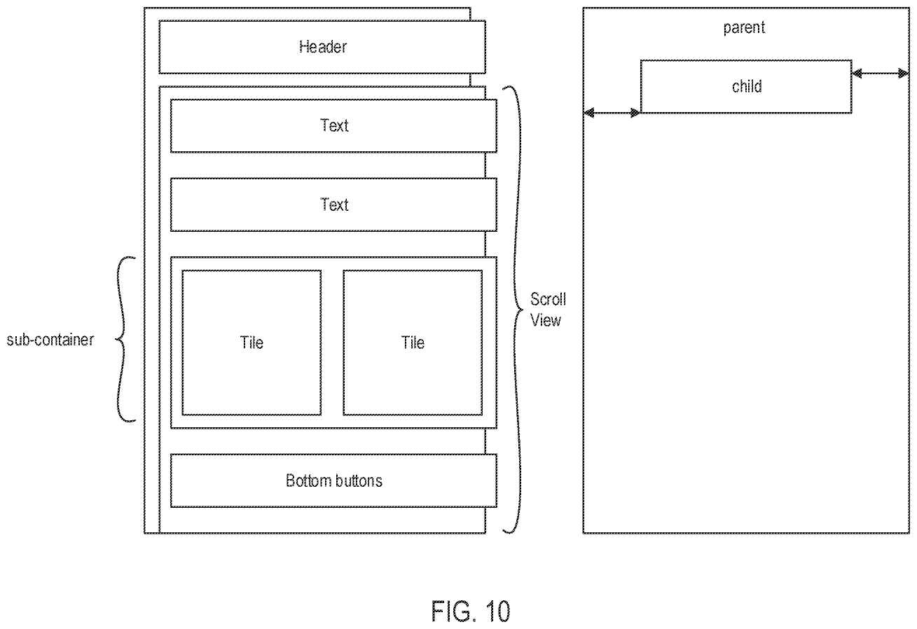

Referring now to FIG. 10, depicted is a block diagram of an example user interface used by the system for managing layouts for plugins. Components in the layout engine may have little to no styling and let the layout engine handle the placement. This may be analogous to a web grid or column based template as depicted. The grid may define properties such as the number of columns, gutter, and padding, among others. This approach may ensure that the consistency and balance of the UI is optimal. On a mobile screen it is not a grid system, but a stack with a header and sometimes wrapped in a tab view. In the depicted example, components such as text, tile, header, and buttons may be placed into a container. In this case, the container can be the screen, scroll view, and sub-container. The layout engine may control the containers and styles around the container, such as the padding, margin, and position of each container, among others.

In a react application, padding, margin, positions of containers may be defined in the screen component for each screen or page of the application. Using a domain specific language (DSL) script, the defined layout may not rely on creation of new code for each page and individual component. In this component and module driven approach, most of an application code base may reside in component composition and screen composition, enabling re-use of the functions multiple times without having to code them from scratch. This may be a big win as this may enable focusing more on improving the therapeutics and evolving them, as opposed to building the applications from ground up, every time.

As with a grid system, styling may be dependent on its parent container, so the layout engine may need to support passing this kind of information to the child component. Having everything in a DSL also may permit querying of the tree. The layout engine may also support spacing, floats, containers, gap spacing, alignment, nesting, and scrolling, among other functions. The layout engine may also handle visibility, some animation, accessibility awareness, orientation, keyboard avoidance.

For example, with a YAML configuration file, first off the root node may be for type navigation. The layout engine reading this may create a navigation stack identifying a list of screens that are a part of a flow. The root node may also have a “screen:property” where a list of screens in the stack may be defined. A new screen may be created with the “id:splash-screen” field indicating that the layout engine is to hide the header. It should be scrollable so if the content on the screen is too big it may scroll. The layout engine may also look at all the child nodes of input type to determine whether to build a special layout to accommodate keyboard aware layouts. Then the screen may have a “layout:property” with a list of components to render top to bottom. The rest may be text and the next may be block. The block may indicate to the layout engine to create a floating box pinned to the bottom-of-screen.

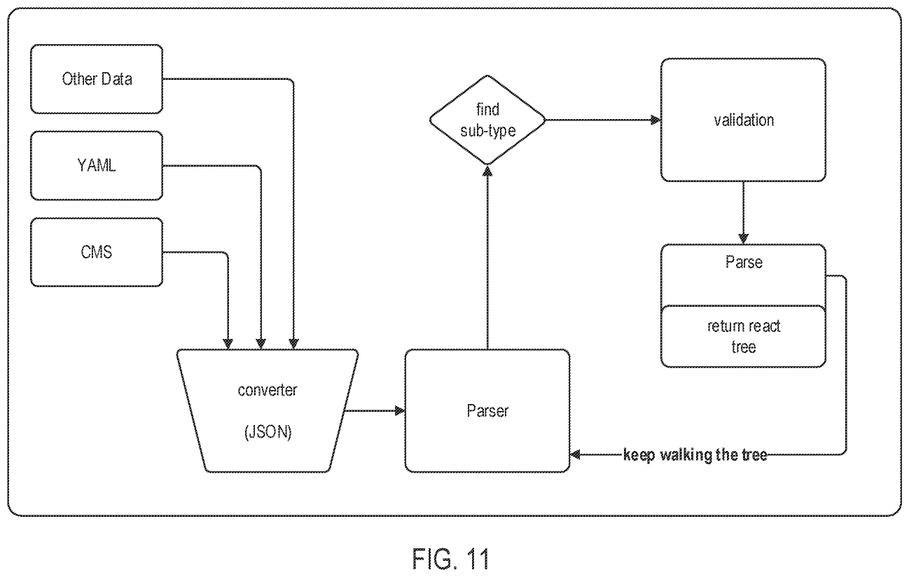

Referring now to FIG. 11, depicted is a flow diagram of a process for parsing configurations in the system for managing layouts in plugins. First, the layout engine may read in the YAML file via a metro bundler plugin. This plugin may convert a YAML file into an intermediary (e.g., JSON) in the case where YAML may not be the native layout engine format, but JSON is. For example, many CMS output JSON or YAML (or another type of DSL) to be converted into JSON. Second, the JSON file may be scanned for references or import ($ref, $id) to reference different parts of the JSON tree. The parts of the JSON tree may be reused without copying any parts of a configuration file. This may make reusing blocks of JSON easier.

Third, the parser may be a recursive function that traverses the tree converting each JSON node into a react render tree. The parser may use the type field in the JSON to determine which sub parser function should handle the conversion. For example, the “type=text” may signal the text parser function to process that node and sub nodes. Fourth, each sub-parser also may define a validation policy, so the schema can be validated before handing the function off to the parser for further processing. This validation may be, for example, a type def file in TypeScript. The parsed node may be used to auto generate documentation and enforce type rule. The layout can handle runtime validation, such as number ranges and conditionals, among others. ajv may be used to perform the validation. Native JSON may be used as a validator, and may be used to support custom functions.

Fifth, each sub-parser may convert each node into a react component. Each sub parser can pass its child nodes to be parsed by the main parser recursively or use the child configuration. In most cases, the YAML tree may mirror the react render tree. Finally, after walking the configuration tree, the parser may obtain the react tree. The system may be designed to be flexible to make the DSL dynamic, with each node in the tree handled by a sub-parser or function. This may permit addition of new semantics to the DSL without having to rewrite the main parser.

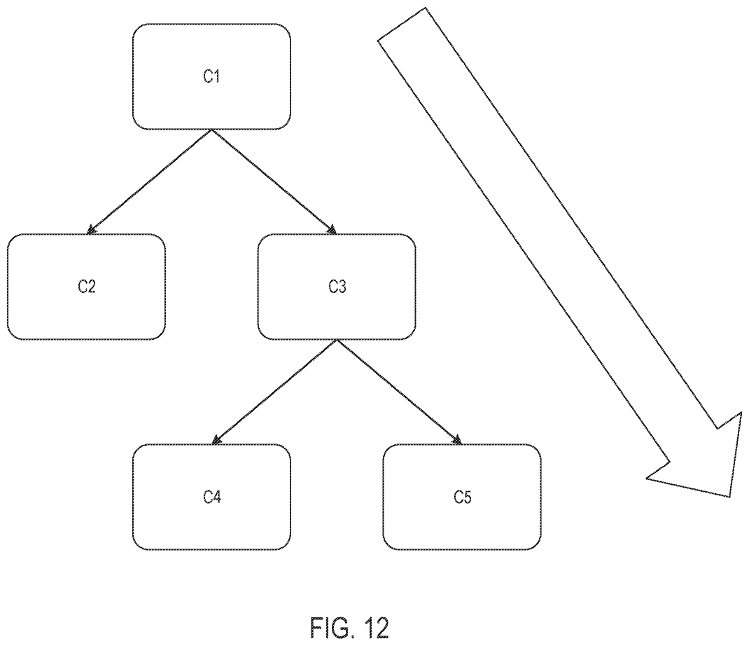

Referring now to FIG. 12, depicted is a block diagram of a configuration tree generated by the system for managing layouts for plugins. In addition to walking the tree, the parser may send additional context with each step. This information may let the parent nodes pass information down and receive information from sub-nodes. These may include namespacing information to each node for its path; hard overrides to permit a parent node to override any key or values from the YAML key or values or supplement the key or values with defaults; and soft overrides to let the YAML key or values override the parents values similar to a default value. When walking the tree, hard and soft overrides may be passed. Soft defaults may be passed, so in the YAML certain values or properties may be omitted. A hard override may be passed so that the parent node can force override the value in the YAML file. For example, with padding/margin in a grid layout, the overriding may pass data up or down the tree to let grid layout components have access to useful data.

Any part of the application can register a parser. The parser may specify the parse function, schema definition used to validate the DSL config values. In the example above, there may be a text and block sub-parser, registered with the layout engine. For example, the text sub-parser may include the following. First, it may include a scheme.yml. This may define the ajv validation rules. In the file, required fields are “valued” and the properties fields may include style, value, markdownStyles, variant. Referring to the field “$ref: common/style”, the global type can be defined as an import without copy or pasting. The top field may be text, and may be used when traversing a YAML file. When a type: text is found, this sub-parser may be used. Second may be a theme.yml discussed later. The third may be Text.js. This file may include a react component to not rely on the layout engine, and may be a functional component with an isolated state. The fourth may be Index.js. This may register the sub parser to the layout engine. The fifth may include a unit test to test the react component and YAML generated versions.

### b. Navigation

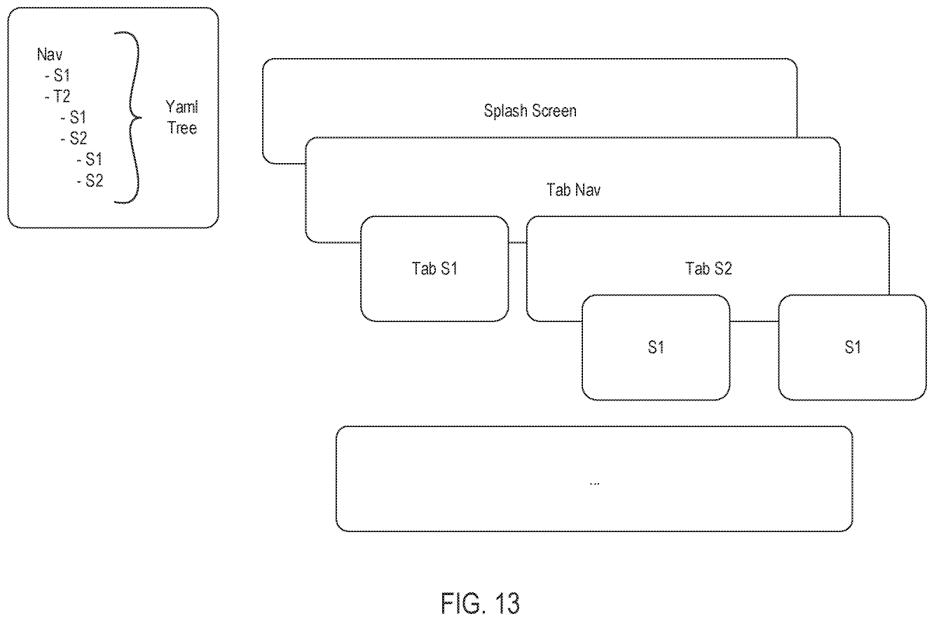

Referring now to FIG. 13, depicted is a block of an example tree and navigation screens generated by the system for managing layouts for plugins. The layout engine may also be responsible for not only laying out a screen, but also defining flows. A navigation sub-parser and tab navigation sub-parser can define trees as depicted. Within each sub-parser, there may be screens for each screen in the stack or tab navigator. The YAML can also define configuration such as header style and deep linking, among others. The behavior engine can carry out various functions, such as push, navigate to, or restore state via deep linking, among others. In this manner, the logic for most of the navigation, deep linking, and other functionalities can be moved out of react native and into the DSL. For example, reconfiguring an application to have three tabs versus five tabs may be a relatively simple change in YAML. The flow of screens can be modified without changing the native code.

### c. Flexibility & Isolation

An additional benefit to splitting the react component out and the sub parser may be the exportation of the react component to projects without the layout engine. Additionally, any component not built for the layout engine can be imported, using a wrapper and sub-parser. Components may be pulled from other parts of code base. Finally, the layout parser can be partitioned into a handcrafted screen, component, or function, as a step in the layout engine flow. The layout engine may return a react tree to use in react code as if a component. The other applications may not use the layout engine to include some of the screens developed to run in the layout engine.

### d. Other Layout Considerations

As a companion to the layout engine, there may be definition of theme and customization of each component for an environment. This may be in consideration of various factors: support for operating systems (OS) themes (e.g., light and dark mode); support for accessibility; support for localization and internationalization; definition of a design language; support of variants; common layout or grid system; color palettes; localized assets; number of columns in a layout; and reusability across multiple applications.

A component in the layout engine can be customized for different environments. This may be not only styles but also layout, assets, localization rules, and other customizations. Components may have appearances and behaviors. In a CMS, this behavior may be controlled within themes. There may be multiple applications generated using these components. Thus, one app may have an input validation shown below the field, whereas another application may specify that the validation is to be a flash message. In addition, a dark theme may entail use of different assets to match the color, or localization may need different assets. One application may use animated or accessibility zooming buttons whereas another app may lack animations and font zooming support. In dark mode there may be different color and padding.

A shared component may reside in an environment. The environment may be an application (or multiple applications) in different states. Then in any state, there may be further customizations for that component. The component may be flexible and support a variety of features that can be turned on or off. In addition to the visual characteristics, default behavior for its environment may be defined. The configuration may be moved into the layout engine from the YAML, but in that case each time an application is to use a button the application may use the configuration over and over. A single theme file that defines the visual characteristics of a button and how its default options are set may be used. The layout engine and YAML may not define this over and over, but the theme file may do so for the application.

The layout engine may enforce the separation. For example, the layout engine may direct that a button is to be placed on a screen. From the point of view of the application, the application may request for a button. The current theme may facilitate this for the style and also support accessibility zooming, so that button can change some of its behavior and visual characteristics. The main point may be that themes are not just color, padding, and font size, among others, but also additional configuration that can be passed into the button component. The flexibility of the theme can have variants, among others. A validation YAML may be placed next to the code, and theme.yaml may be placed next to the validation file as well. All the components options may be placed in a single place corresponding to a single format YAML.

### 4. Assets

Assets may be part of the theme. When a button is to be added with a thumb up icon, the application may identify the correct icon for that theme. A registry may be created, so each theme can define an asset. If not defined in a theme, the application may fall back to the base theme. Each asset may belong to a theme, so assets are per theme. The assets may also be typed in various formats (e.g., SVG, MP4, Lottie).

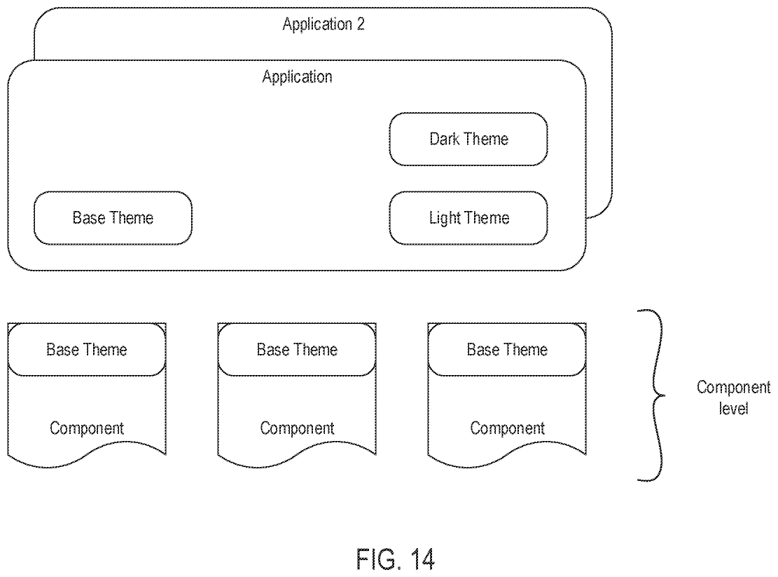

Referring now to FIG. 14, depicted is a block diagram of theme configurations used in the system for managing layouts for plugins. As depicted, there may be two types of themes and two boundaries the theme exists in. The first boundary may be a component and the next may be for a specific application. Within each boundary, there may be two types of themes, with one corresponding to a base theme and the other corresponding to a named theme (e.g., light or dark mode).

The base theme may define sensible defaults. The base theme may be in the component boundary, and all the applications may obtain these defaults for the respective components. For the application boundary, the base theme may be applicable to that specific application. The other type may be a named theme (e.g., dark and light) that does not apply to the component boundary, but the application boundary. Additionally, the application may have one active theme at a given time. A component boundary may create more isolation. Different applications may import shared components to update all the base themes of the application each time a component theme variable is to be changed.

Regarding themes, a theme may specify whether the theme is a base theme or a named theme. A priority may be defined for that theme. Merging all the theme data may collapse the set of themes into a single theme configuration for a particular application, so that there is no reliance on each user of theme data having to perform these configurations. Using which application is running and which theme is active, automatic merging may be used to provide a single decision for the application. For example, by default, a priority value of 10 may be provided for the application and 100 for the component.

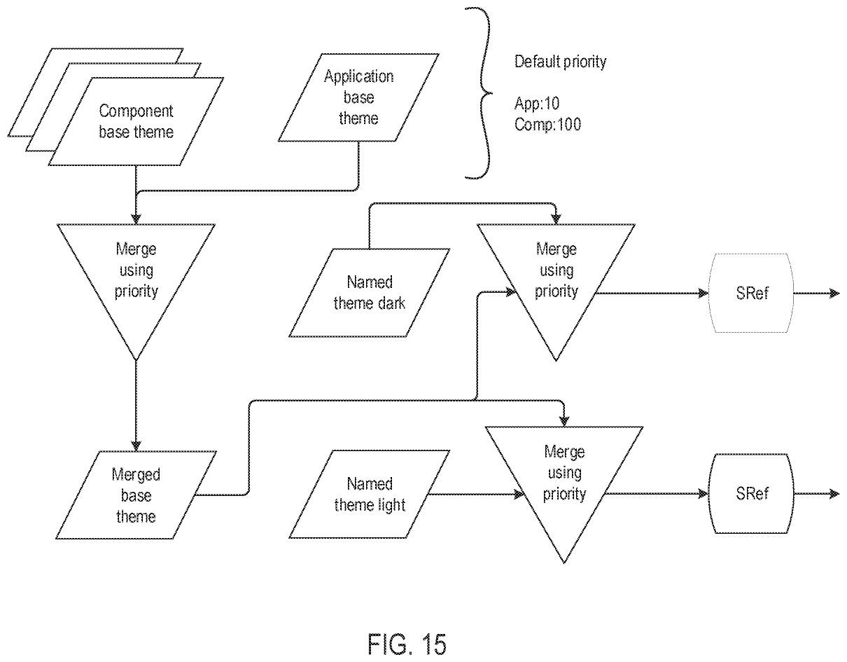

Referring now to FIG. 15, depicted is a flow diagram of a process for merging themes according to priority in the system for managing layouts for plugins. First, the theme provider may merge all the base themes from both boundaries, including component and application boundaries. The theme provider may use the priority number between 0-100 to figure out the merge order. After the merge is done, a single combined object that represents the merged base theme with priority 0 winning over priority 100 may be obtained. The theme provider may merge all the name themes one by one. If there are two themes for light and dark, the two combined merged objects may be calculated. This step may use the same logic as step 1 in terms of priority.

With the identification of the base and named themes, the theme provider may select the active theme and merge the selected theme on top of the base themes. As such, the theme provider may have defaults from the base theme. The theme provider may walk the combined base or named themes searching for $ref, updating the values to point to the correct part of the object, and replacing $ref with real values. The theme provider may optimize the theme by compiling React Native StyleSheets and cache the result.

Regarding $ref and shared values, in many cases variables such as textColor may be used. In a theme, $ref may allow this as the value. This may refer to a different part of the configuration. This $ref may be applicable across all merging to permit use of a value defined in a different named or component theme. This can be useful, for example, when there is a text component and this may be used to define a style such as a body. When there is an input field and the exact same body style is to be used, the field $ref may be used.

As the merging is performed first, then the $ref replacement is the final step, the application theme or base theme can override that body style, and both the text and input field may use that value. Finally, as the configuration may be used as style, the configuration file may have a YAML structure to import any kind of namespace. For example, the file may specify button.primary.layout.padding=100. This may make the style namespace more expressive. Regarding variants, the namespace may be used to create the variants. This may be an override value. Then, a component can have a property variant and all the theme providers may merge the namespaced variant value to the theme. This may permit a button to have different variants. This may also be done for states.

### C. System and Method for Configuring & Handling Finite State Machines for Applications for User Related Conditions

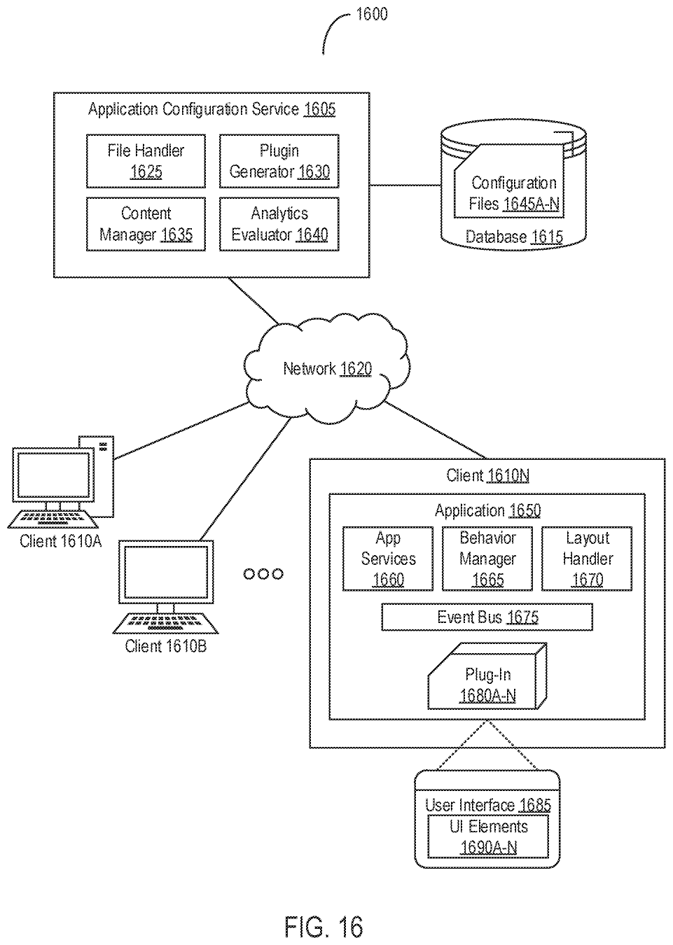

Referring now to FIG. 16, depicted is a block diagram of a system 1600 for providing finite state machines (FSMs) in applications. In overview, the system 1600 may include at least one application configuration service 1605, one or more clients 1610A-N (hereinafter generally referred to as clients 1610), and at least one database 1615, communicatively coupled with one another via at least one network 1620. The application configuration service 1605 may include at least one file handler 1625, at least one plugin generator 1630, at least one content manager 1635, and at least one analytics evaluator 1640.

The database 1615 may store, maintain, or otherwise include at least one configuration file 1645A-N (hereinafter generally referred to as a configuration file 1645). Each client 1610 may include at least one application 1650. The application 1650 may include at least one application service 1660, at least one behavior manager 1665, at least one layout handler 1670, at least one event bus 1675, and at least one plug-in 1680A-N (hereinafter generally referred to as plug-in 1680), among others. The application 1650 may also provide at least one user interface 1685 including one or more user interface elements 1690A-N (hereinafter generally referred to as user interface elements 1690).

Each of the components in the system 1600 (e.g., the application configuration service 1605 and its components and each client 1610 and its components) may be executed, processed, or implemented using hardware or a combination of hardware, such as the system 1900 detailed herein in Section D. The components of the system 1600 may be also used to execute, process, or implement the functionalities detailed herein in Sections A and B. For example, the application configuration service 1605 and the application 1650 may execute the operations detailed in conjunction with the behavior engine and the layout engine as described in the Sections above.

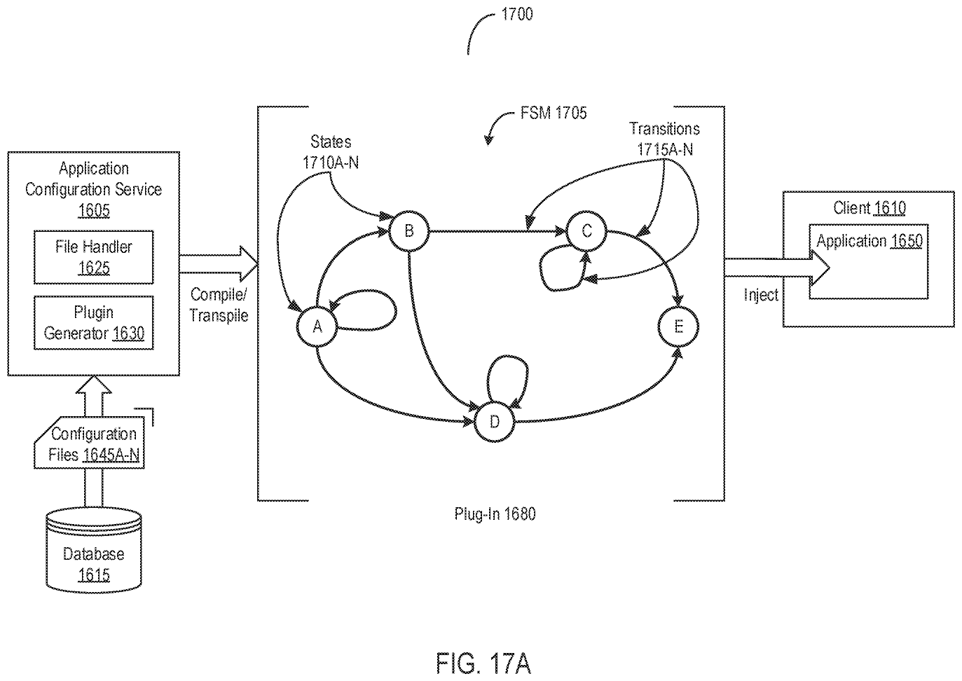

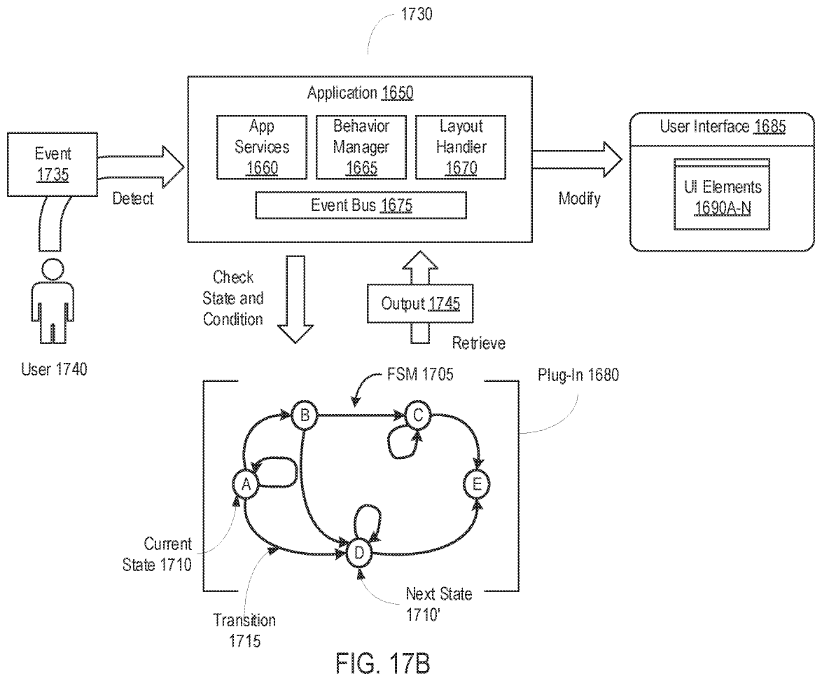

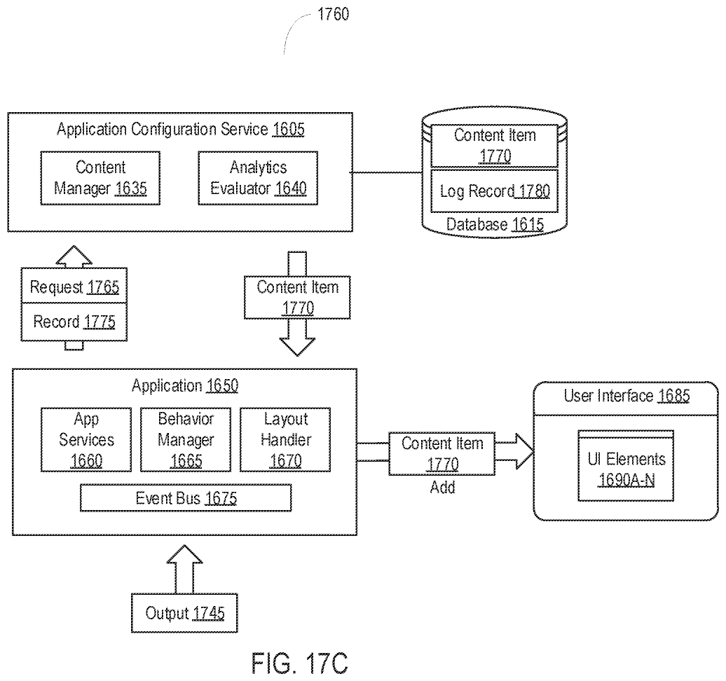

Referring now to FIG. 17A, depicted is a block diagram of a process 1700 for generating instructions in the system 1600 for providing finite state machines (FSMs) in applications. The process 1700 may correspond to the operations of the application configuration service 1605 to generate and provide plug-ins 1680 to the client 1610. Under the process 1700, the file handler 1625 executing on the application configuration service 1605 may retrieve, fetch, or identify at least one configuration file 1645 (e.g., a first configuration file 1645A) from the database 1615. In some embodiments, the file handler 1625 may retrieve, obtain, or receive the configuration file 1645 from another source, such as a computing device of a developer creating the configuration file 1645. The configuration file 1645 may include instructions (e.g., a script including human-readable instructions) for configuring, defining, or otherwise specifying various functionalities of the plug-in 1680 to be added to the application 1650. The functionalities specified by the configuration 1645 may be separate from the built-in logic and functionalities of the application 1650, such as those of the application service 1660.

In some embodiments, the instructions included in the configuration file 1645 may be in a human-readable format, such as Yet Another Markup Language (YAML), Extensible Markup Language (XML), and JavaScript Object Notation (JSON), among others. In this manner, the effort undertaken by a developer in writing the human readable instructions in the configuration file 1645 may be less than that of composing instructions in other formats.

The instructions in the configuration file 1645 may specify, identify, or otherwise define at least one finite state machine (FSM) 1705. The FSM 1705 may be for a set of routines to address a condition of a user of the application 1650. For example, the condition may include smoking, obesity, psychological disorders (e.g., Schizophrenia), mental cognition, and depression, among others, on the part of the user. The routines set out by the FSM 1705 may include various treatments or management of these different conditions. The routines may be common or may vary for different types of conditions. For example, for treating smoking or obesity, there may be common activities specified in the routines such as hydration. For smoking, obesity, and depression, the routines set out by the FSM 1705 may include fitness work or a breathing exercise, among others. The set of routines may form steps along a journey of a user to achieve the target behavioral endpoint for the given condition, such as cessation of smoking. The activities may be recorded via the application 1650 running on the client 1610 of the user.

In some embodiments, the routines for the configuration files 1645 (and by extension, the FSMs 1705) may be selected from a library of routines maintained on the database 1615. The routines may be selected by the developer of the configuration file 1645 or the plug-in 1680 or by the file handler 1625 using conditions to be targeted by the configuration file 1645 or the plug-in 1680. The library may include instructions for identifying or defining various routines, such as fitness exercise, walking, breathing, hydration, or reading a message, among others. The ability to select different routines may allow for targeting of specific conditions, and may also allow instructions in the configuration files 1645 to be used in a wide variety of applications 1605. For example, one configuration file 1645 detailing the routines for a breathing exercise may be used for an application 1605 aimed at smoking cessation and another application 1650 aimed at obesity.

The FSM 1705 may identify or include a set of states 1710A-N (hereinafter generally referred to as states 1710) and a set of transitions 1715A-N (hereinafter generally referred to as transitions 1715). Each state 1710 may define, identify, or otherwise specify an output to be produced by the FSM 1705 when invoked. In some embodiments, at least one state 1710 may specify invocation of another FSM 1705 in the set of FSMs 1705. The output may be for a particular routine in the set of routines associated with the FSM 1705, and may identify user interface elements 1690 to be presented via the user interface 1685 of the application 1650. In some embodiments, the output may specify one or more identifiers (e.g., uniform resource locator (URL)) for content items to be provided to the user interface 1685. For example, the output of the state 1710 may be for display of a smoking cessation tip message, upon the user having completed a walking exercise.

Each transition 1715 may define, identify, or otherwise specify an event to be detected via the application 1650 to update the FSM 1705 from one state 1710 to another state 1710. In some embodiments, at least one transition 1715 may specify the event to be detected to invoke another FSM 1705 in the set of FSMs 1705. For example, the transition 1715 may be to an initial or other defined state of the other FSM 1705. The event may correspond to an action to be performed via the application 1650 for the associated routine. For instance, the transition 1715 may specify to move from one state 1710A to the next state 1710B, the user is to record completion of a breathing exercise via the user interface 1685 of the application 1650. Each state 1710 may have one or more transitions 1715 associated with the state 1710.

In some embodiments, the file handler 1625 may retrieve, fetch, or identify a configuration file 1645 (e.g., a second configuration file 1645B) for presentation of user interface elements 1690 associated with the FSM 1705 for the user interface 1685 of the application 1650. In some embodiments, the configuration file 1645B for the presentation of user elements via the user interface 1685 may be the same as the configuration file 1645A defining the FSM 1705. In some embodiments, the configuration file 1645B for the presentation of user interface elements 1690 may be separate from the configuration file 1645A defining the FSM 1705. The configuration file 1645 may specify, define, or otherwise identify the user interface elements 1690 for the output at each state 1710 in the FSM 1705. The user interface elements 1690 for output specified by the configuration file 1645 may be shared across multiple states 1710, and multiple FSMs 1705. The user interface elements 1690 may be defined in terms of visual properties, such as color, font size, and placement, among others. The user interface elements 1690 may correspond to assets (e.g., images, videos, or other object) to be retrieved by the application 1650 from the application configuration service 1605 (or another remote server).

The plugin generator 1630 executing on the application configuration service 1605 may produce, output, or otherwise generate the plug-in 1680 using the one or more configuration files 1645 (e.g., the human-readable instructions of the configuration file 1645A defining the FSM 1705). The plug-in 1680 may include instructions for configuring, defining, or otherwise specifying various functionalities to be performed on the application 1650. The instructions in the plug-in 1680 may be in an intermediary format (sometimes referred herein as a transpiled or translated format). For example, the instructions for the plug-in 1680 may be translated from the human-readable instructions to the intermediary format, such as JavaScript Object Notation (JSON), TypeScript, Swift, or Python, among others. The instructions for the plug-in 1680 may also define the FSM 1705, including the set of states 1710 and the transitions 1715. Each plug-ins 1680 may be associated with one or more conditions to be addressed by performing the specified routines.

In addition, the instructions for the plug-in 1680 may also define the user interface elements 1690 for the outputs in the states 1710 in the FSM 1705. Because the plug-in 1680 is generated separately from the application 1650, which plug-ins 1680 the application 1650 is to include may be readily interchanged, based on the condition of the user to be addressed. In generating, the plugin generator 1630 may create a separate file in which to store the specifications for the plug-in 1680. The plugin generator 1630 may parse the one or more configuration files 1645 to read or identify the instructions in the original format. In some embodiments, the plugin generator 1630 may parse the configuration file 1645A defining the FSM 1705 and the configuration file 1645B defining the user interface elements 1690 for the output in series or in parallel, while generating the plug-in 1680.

Upon identification of the configuration file 1645 (e.g., the configuration file 1645A), the plugin generator 1630 may generate or determine an equivalent instruction in an executable format for inclusion into the application 1650. The plugin generator 1630 may translate or transpile (e.g., using a transpiler or converter) the configuration file 1645 to generate instructions in an intermediary-format to be added to the application 1650 (e.g., into JavaScript Notation Object (JSON) format, TypeScript, Swift, or Python formats). In some embodiments, the plugin generator 1630 may compile the configuration file 1645 to generate instructions in a lower-level language. When compiled, the instructions for the plug-in 1680 may be in a lower-level language, such as byte code, assembly, object code, or machine code, among others. In some embodiments, the lower-level language compilation may be performed by the application 1650 on the client 1610. Upon generation, the plugin generator 1630 may write the equivalent instruction into the file for the plug-in 1680, and may repeat until the end of the configuration file 1645.

With the generation, the plugin generator 1630 may transmit, send, or otherwise provide the instructions for the plug-in 1680 to add or include to the application 1650. In some embodiments, the plugin generator 1630 may insert or inject the plug-in 1680 into the application 1650, prior to installation on the client 1610. For example, the plugin generator 1630 may inject the plug-in 1680 into the application 1650 that already includes the other components, such as the application services 1660, the behavior manager 1665, the layout handler 1670, and the event bus 1675, among others. The plugin generator 1630 may provide the application 1650 containing the injected plug-in 1680 to the client 1610 via a digital distribution platform (e.g., application market or store) to be loaded by the application 1650 installed on the client 1610. The client 1610 may request to download or retrieve the application 1650 from the application configuration service 1605 (or the digital distribution platform) for installation. Once received, the client 1610 may unpack and install the application 1650 including the plug-in 1680.

In some embodiments, the plugin generator 1630 may provide the instructions for the plug-in 1680 to add or include the application 1650 installed on the client 1610. For example, the client 1610 may have previously installed the application 1650 received from the application configuration service 1605 (e.g., via the digital distribution platform). In some embodiments, the client 1610 may subsequently send a request for routines to the application 1650. The request may identify one or more routines to be performed by the user to address a condition via the application 1650. Based on the routines identified in the request, the plugin generator 1630 may identify or select one or more plug-ins 1680 for the corresponding routines to provide to the application 1650 on the client 1610. In some embodiments, the plugin generator 1630 may identify or determine that an update is to be provided to the application 1650 to provide instructions for the plug-in 1680. For instance, a system administrator of the application configuration service 1605 may direct that instances of the application 1650 are to be updated. With the identification of the update, the plugin generator 1630 in turn may provide the instructions for the plug-in 1680, without providing the other components of the application 1650.

Upon receipt, the client 1610 (or the application services 1660 running in the application 1650) may update the application 1650 to include the plug-in 1680. The client 1610 may store the plug-ins 1680 to be load to the application 1650. Upon execution, the application 1650 may load the plug-ins 1680 to carry out the routines specified by the routines 1680. In some embodiments, the received instructions for the plug-in 1680 may be in the intermediary format. The application 1650 may further compile the instructions to generate the lower-level format to run on the client 1610. For example, the client 1610 or the application 1650 may compile the configuration file 1645 to generate instructions in a lower-level language. When compiled, the instructions for the plug-in 1680 may be in a lower-level language, such as byte code, assembly, object code, or machine code, among others. In some embodiments, in updating, the client 1610 (or the application 1650) may substitute or replace old plug-ins 1680 with routines to address the same condition as the newly received plug-ins 1680. Upon receipt, the application 1650 may identify previously provided plug-ins 1680 for addressing the same condition as the newly received plug-ins 1680. With the identification, the application 1650 may delete or otherwise remove the previously provided plug-ins 1680.

Referring now to FIG. 17B, depicted is a block diagram of a process 1730 for handling finite state machines (FSMs) in the system 1600 for providing finite state machines (FSMs) in applications. The process 1730 may correspond to the operations at the client 1610 upon executing the application 1650. Under the process 1730, the application services 1660 executing on the application 1650 may perform initialization operations, such as starting the execution of the behavior manager 1665, the layout handler 1670, the event bus 1675, and the user interface 1685, among others. The application services 1660 may run various logic and operations defined for the application 1650 outside of the set of plug-ins 1680.

The behavior manager 1665 of the application 1650 executing on the client 1610 may instantiate, initialize, or otherwise establish the set of FSMs 1705 in the plug-ins 1680 included with the application 1650. In some embodiments, the behavior manager 1665 may select or identify one or more from the set of FSMs 1705 for the routines to address a particular condition of a user 1740. For example, during initialization, the behavior manager 1665 may receive user input indicating the condition of the user 1740 to be addressed via the routines provided through the FSMs 1705. Using the user input, the behavior manager 1665 may select the FSMs 1705 to load from the overall set. In at least a subset of the FSMs 1705, each FSM 1705 may correspond to a particular set of routines, such as a fitness workout, breathing exercise, de-stressing activity, hydration, and a smoking cessation reminder, among others.

In initializing, the behavior manager 1665 may connect the loaded FSMs 1705 with the event bus 1675 to facilitate communications among the FSMs 1705 and the various components of the application 1650. The event bus 1675 may correspond to an interface among the plug-ins 1680 and the various components of the application 1650, such as the application services 1660, the behavior manager 1665, and the layout handler 1670. With the connection, the behavior manager 1665 may distribute or convey events corresponding to user interactions with the application 1650 via the event bus 1675 to each FSM 1705. The recipient FSMs 1705 in turn may process and handle the events conveyed via the event bus 1675.

In addition, for each FSM 1705 in the respective plug-in 1680, the behavior manager 1665 may keep track of a current state 1710 of the FSM 1705. The behavior manager 1665 may keep track of the current state 1710 of each FSM 1705 via the event bus 1675. In some embodiments, the behavior manager 1665 may send a ping or query (e.g., at a sample period) each FSM 1705 for the current state 1710 over the event bus 1675. In some embodiments, each FSM 1705 may provide (e.g., at a sample period) the current state 1705 to the behavior manager 1665 via the event bus 1675. In some embodiments, the behavior manager 1665 may use or maintain an identifier for the current state 1710 for each FSM 1705 to keep track. Upon initialization, the current state 1710 of each FSM 1705 may correspond to the start state 1710 (e.g., state 1710A as depicted) of the FSM 1705.

In conjunction, the behavior manager 1665 may monitor or listen for at least one event 1735 on one or more of the user interface elements 1690 in the user interface 1685 via the event bus 1675. The event 1735 may correspond to at least one action performed by the user 1740 of the application 1650. For example, the user interface 1685 may present a prompt for the user 1740 to conduct a breathing exercise, and the user 1740 may indicate the completion of the exercise via user interaction with one of the user interface elements 1690 on the user interface 1685. In some embodiments, the behavior manager 1665 may monitor or listen for the event 1735 from another process of the application 1690 or client 1610. The event 1735 in this case may correspond to an occurrence of an action by a process of the application 1690 or the client 1610 that was not triggered by an interaction from the user 1740. For example, the behavior manager 1665 may receive data identifying date and time from a system timer on the client 1610, and recognize the receipt of the data as the event 1735.

In response to the detection of the event 1735, the behavior manager 1665 may determine or select at least one FSM 1705 in a corresponding plug-in 1680 to invoke. In some embodiments, the behavior manager 1665 may convey or pass the detected event 1735 to the plug-ins 1680 via the event bus 1675. As discussed above, the event bus 1675 may correspond to an interface among the plug-ins 1680 and the various components of the application 1650. The event bus 1675 may be used to relay, convey, or otherwise provide invocations and signals among the plug-ins 1680 loaded onto the application 1650. By passing, the behavior manager 1665 may check the detected event 1735 against the event specified by the transitions 1715 for the current state 1710. As discussed above, the behavior manager 1665 may keep track of the current state 1710 of each FSM 1705 in the respective plug-in 1680. In some embodiments, the behavior manager 1665 may detect or receive the result of the checking of the detected event 1735 via the event bus 1675.

For each FSM 1705, the behavior manager 1665 may identify the specified event for each transition 1715 associated with the current state 1710 to check against the detected event 1735. When the detected event 1735 does not correspond to the specification in any of the transitions 1715 of the current state 1710, the behavior manager 1665 may maintain the FSM 1705 at the current state 1710 (e.g., state 1710A as depicted). In some embodiments, the behavior manager 1665 may also refrain from invoking the FSM 1705. The maintenance of the FSM 1705 at the current state 1710 may correspond to the user 1740 not having completed a routine of the set of routines set out for the FSM 1705 for any of the transitions 1715 associated with the current state 1710. The behavior manager 1665 may continue to check the detected event 1735 against the specifications of the FSMs 1705 in other plug-ins 1680.

Conversely, when the detected event 1735 corresponds to the specification in one of the transitions 1715 of the current state 1710, the behavior manager 1665 may select the FSM 1705 to invoke. By invoking, the behavior manager 1665 may update the current state 1710 of the FSM 1705 to the next state 1710′ in accordance with the transition 1715 (e.g., as shown). The updating of the FSM 1705 from the current state 1710 to the next state 1710′ may correspond to the user 1740 having completed a routine of the set of routines set out for the FSM 1705 as identified for at least one of the transitions 1715 associated with the current state 1710. In addition, from invoking the FSM 1705 of the plug-in 1680, the behavior manager 1665 may retrieve or identify an output 1745 identified by the next state 1710′ of the FSM 1705. The output 1745, as discussed above, may identify the user interface elements 1690 to be presented via the user interface 1685 of the application 1650. In some embodiments, the output 1745 may specify modifications to be applied to the user interface elements 1690 of the user interface 1685. The behavior manager 1665 may convey or pass the output 1745 to the behavior manager 1665 via the event bus 1675.

Referring now to FIG. 17C, depicted is a block diagram of a process 1760 for modifying a user interface 1685 in the system 1600 for providing finite state machines in applications. The process 1760 may correspond to the operations of the application configuration service 1605 and application 1650 upon invocation of one of the FSMs 1705 in a plug-in 1680. Under the process 1760, the layout handler 1670 of the application 1650 executing on the client 1610 may update, change, or otherwise modify the user interface elements 1690 of the user interface 1685 in accordance with the output 1745. By setting the user interface 1685, the layout handler 1670 may associate or bind the states 1710 in the FSM 1705 of the plug-in 1680 to the user interface elements 1690 of the user interface 1685. In some embodiments, the layout handler 1670 in conjunction with the behavior manager 1665 may maintain the association or binding of the states 1710 of the FSM 1705 and the user interface elements 1690 of the user interface 1685. For example, the layout handler 1670 may keep track of a relationship between the state 1710 of the most recently invoked FSM 1705 and the user interface elements 1690 rendered or presented via the user interface 1685.

In modifying, the layout handler 1670 may determine whether to send a request 1765 for content to the application configuration service 1605 (or to another remote service). The output 1745 may rely on at least one content item 1770 (e.g., images, videos, and other objects) to be provided during the runtime of the application 1650 from the application configuration service 1605. If the output 1745 does not specify for the retrieval of the content item 1770, the layout handler 1670 may refrain from transmitting the request 1765 for content to the application configuration service 1605. The layout handler 1670 may also continue to modify the user interface elements 1690 of the user interface 1685 in accordance with the output 1745. On the other hand, if the output 1745 specifies for the retrieval of the content 1765, the layout handler 1670 may determine to send the request 1765 for content to the application configuration service 1605. The layout handler 1670 may generate the request 1765 for content to include at least one identifier referencing the content item 1770 to be retrieved from the application configuration service 1605. The identifiers may be specified by the output 1745 from the now-current state 1710 of the FSM 1705.

The content manager 1635 executing on the application configuration service 1605 in turn may retrieve, identify, or otherwise receive the request 1765 for content from the client 1610. In some embodiments, the content manager 1635 may reside on a remote service separate from the application configuration service 1605 accessible via the network 1620. The content manager 1635 may parse the request 1765 to identify the content item 1770 to be provided to the client 1610 for presentation on the user interface 1685. In some embodiments, the content manager 1635 may use the identifier in the request 1765 to access the database 1615 to retrieve, fetch, or identify the content item 1770 referenced by the identifier. The content item 1770 may be information in a visual or audio medium, and may include an image, a video, an audio, or any other object to be presented on the user interface 1685. For example, the content item 1770 may include an audio to be played in conjunction with a fitness exercise for the routines associated with the invoked FSM 1705. With the identification, the content manager 1635 may send, return, or otherwise provide the content item 1770 to the client 1610.

The layout handler 1670 may in turn retrieve, identify, or receive the content item 1770 from the application configuration service 1605 (or the remote service). Upon receipt, the layout handler 1670 may insert, add, or otherwise include the content item 1770 in the user interface 1685. The layout handler 1670 may include the content item 1770 in one or more of the user interface elements 1690 for presentation as specified in the output 1745 from the FSM 1705. Concurrently, the layout handler 1670 may modify the user interface elements 1690 of the user interface 1685 in accordance with the output 1745. For example, the layout handler 1670 may instantiate the user interface elements 1690, set the color and other visual characteristics of the individual user interface elements 1690 themselves, set the font and size of the text in the individual user interface elements 1690, and assign the placement of the user interface elements 1690 within the display of the client 1610. In some embodiments, the layout handler 1670 may provide the indication of the presentation of the content item 1770 via the event bus 1675 to the invoked FSM 1705.

In some embodiments, the layout handler 1670 may generate or determine a render instructions using the output 1745 specified by the FSM 1705. The output 1745 may identify a set of instructions (e.g., in an original or lower-level format) corresponding to the respective user interface elements 1690 to be included in the user interface 1685. The render instructions may be in the form of a display list or render tree. Upon identification, the layout handler 1670 may parse the instructions in the output 1745 corresponding to the set of user interface elements 1690. For each instruction, the layout handler 1670 may generate an equivalent entry (e.g., a render tree node) to include in the render instructions. With the generation, the layout handler 1670 may present the user interface elements 1690 for the user interface 1685 in accordance with the render instructions.

In conjunction, the behavior manager 1665 may send, transmit, or provide at least one record entry 1775 to the application configuration service 1605 (or another remote service). Upon detection of one or more events 1735, the behavior manager 1665 may write or generate the record entry 1775. The record entry 1775 may identify or include various information regarding the running on the plug-in 1680 in the application 1650. In some embodiments, the record 1775 may identify the user action associated with the event 1735 detected via the user interface element 1690 of the application 1650. For example, the record entry 1775 may identify the current states 1710 of each FSM 1705 in the plug-in 1680, the routines completed or remaining for the user 1740 in the FSMs 1705, the detected events 1735, a type of each event 1735, a timestamp corresponding a time at which each event 1735 is detected, an identifier for the user 1740, an identifier for the client 1610, an identifier for an instance of the application 1650, among others. With the generation, the behavior manager 1665 may send the record entry 1775 to the application configuration service 1605.

The analytics evaluator 1640 executing on the application configuration service 1605 may in turn retrieve, identify, or otherwise receive the record entry 1775 from the client 1610. Upon receipt, the analytics evaluator 1640 may add and include the record entry 1775 in a log record 1780 maintained on the database 1615. The log record 1780 may keep track and maintain the record entries 1775 received from various clients 1610. In some embodiments, the log record 1780 may be maintained in accordance with a database management system (DBMS), such as a relational, an object-oriented, or an object-relational DBMS. Using the record entries 1775 maintained in the log record 1780, new plug-ins 1680 may be configured or configuration files 1645 may be modified by the developer.

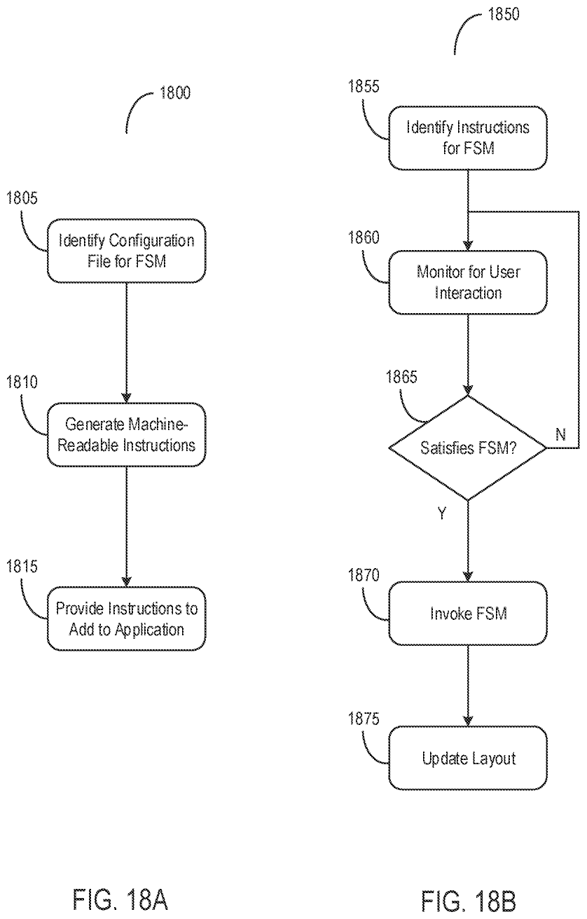

Referring now to FIG. 18A, depicted is a flow diagram of a method 1800 of configuring finite state machines (FSMs) on applications. The method 1800 may be implemented using any of the components as detailed herein above in conjunction with FIGS. 16-17B or 19. Under method 1800, a service may identify a configuration file for a finite state machine (1805). The service may generate machine-readable instructions using the configuration file (1810). The service may provide the machine-readable instructions to add to an application (1815).

Referring now to FIG. 18B, depicted is a flow diagram of a method 1850 of handling finite state machines (FSMs) on applications. The method 1850 may be implemented using any of the components as detailed herein above in conjunction with FIGS. 16-17B or 19. Under method 1850, a client may identify instructions for a finite state machine (1855). The client may monitor for a user interaction (1860). The client may determine whether the detected interaction satisfies a condition of a current state of the finite state machine (1865). When the interaction satisfies the conditions of the current state of the finite state machine, the client may invoke the finite state machine (1870). The client may update a layout in accordance with the finite state machine (1875).

### D. Network and Computing Environment

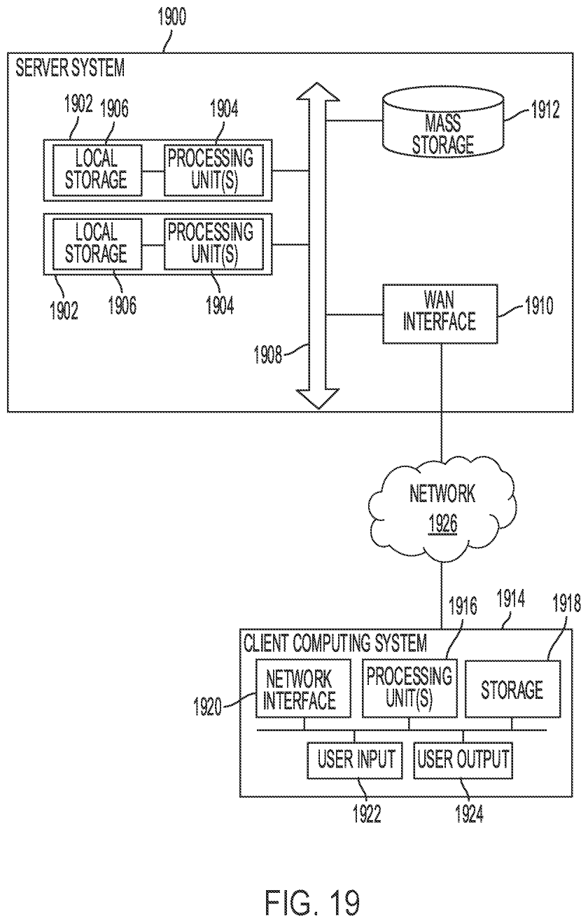

Various operations described herein can be implemented on computer systems. FIG. 19 shows a simplified block diagram of a representative server system 1900, client computer system 1914, and network 1926 usable to implement certain embodiments of the present disclosure. In various embodiments, server system 1900 or similar systems can implement services or servers described herein or portions thereof. Client computer system 1914 or similar systems can implement clients described herein. The system 2300, 2800, and 3300 described herein can be similar to the server system 1900. Server system 1900 can have a modular design that incorporates a number of modules 1902 (e.g., blades in a blade server embodiment); while two modules 1902 are shown, any number can be provided. Each module 1902 can include processing unit(s) 1904 and local storage 1906.

Processing unit(s) 1904 can include a single processor, which can have one or more cores, or multiple processors. In some embodiments, processing unit(s) 1904 can include a general-purpose primary processor as well as one or more special-purpose co-processors such as graphics processors, digital signal processors, or the like. In some embodiments, some or all processing units 1904 can be implemented using customized circuits, such as application specific integrated circuits (ASICs) or field programmable gate arrays (FPGAs). In some embodiments, such integrated circuits execute instructions that are stored on the circuit itself. In other embodiments, processing unit(s) 1904 can execute instructions stored in local storage 1906. Any type of processors in any combination can be included in processing unit(s) 1904.

Local storage 1906 can include volatile storage media (e.g., DRAM, SRAM, SDRAM, or the like) and/or non-volatile storage media (e.g., magnetic or optical disk, flash memory, or the like). Storage media incorporated in local storage 1906 can be fixed, removable, or upgradeable as desired. Local storage 1906 can be physically or logically divided into various subunits such as a system memory, a read-only memory (ROM), and a permanent storage device. The system memory can be a read-and-write memory device or a volatile read-and-write memory, such as dynamic random-access memory. The system memory can store some or all of the instructions and data that processing unit(s) 1904 need at runtime. The ROM can store static data and instructions that are needed by processing unit(s) 1904. The permanent storage device can be a non-volatile read-and-write memory device that can store instructions and data even when module 1902 is powered down. The term “storage medium” as used herein includes any medium in which data can be stored indefinitely (subject to overwriting, electrical disturbance, power loss, or the like) and does not include carrier waves and transitory electronic signals propagating wirelessly or over wired connections.

In some embodiments, local storage 1906 can store one or more software programs to be executed by processing unit(s) 1904, such as an operating system and/or programs implementing various server functions such as functions of the system 2300, 2800, and 3300 or any other system described herein, or any other server(s) associated with system 2300, 2800, and 3300 or any other system described herein.

“Software” refers generally to sequences of instructions that, when executed by processing unit(s) 1904, cause server system 1900 (or portions thereof) to perform various operations, thus defining one or more specific machine embodiments that execute and perform the operations of the software programs. The instructions can be stored as firmware residing in read-only memory and/or program code stored in non-volatile storage media that can be read into volatile working memory for execution by processing unit(s) 1904. Software can be implemented as a single program or a collection of separate programs or program modules that interact as desired. From local storage 1906 (or non-local storage described below), processing unit(s) 1904 can retrieve program instructions to execute and data to process in order to execute various operations described above.

In some server systems 1900, multiple modules 1902 can be interconnected via a bus or other interconnect 1908, forming a local area network that supports communication between modules 1902 and other components of server system 1900. Interconnect 1908 can be implemented using various technologies including server racks, hubs, routers, etc.

A wide area network (WAN) interface 1910 can provide data communication capability between the local area network (interconnect 1908) and the network 1926, such as the Internet. Technologies can be used, including wired (e.g., Ethernet, IEEE 802.3 standards) and/or wireless technologies (e.g., Wi-Fi, IEEE 802.11 standards).

In some embodiments, local storage 1906 is intended to provide working memory for processing unit(s) 1904, providing fast access to programs and/or data to be processed while reducing traffic on interconnect 1908. Storage for larger quantities of data can be provided on the local area network by one or more mass storage subsystems 1912 that can be connected to interconnect 1908. Mass storage subsystem 1912 can be based on magnetic, optical, semiconductor, or other data storage media. Direct attached storage, storage area networks, network-attached storage, and the like can be used. Any data stores or other collections of data described herein as being produced, consumed, or maintained by a service or server can be stored in mass storage subsystem 1912. In some embodiments, additional data storage resources may be accessible via WAN interface 1910 (potentially with increased latency).

Server system 1900 can operate in response to requests received via WAN interface 1910. For example, one of modules 1902 can implement a supervisory function and assign discrete tasks to other modules 1902 in response to received requests. Work allocation techniques can be used. As requests are processed, results can be returned to the requester via WAN interface 1910. Such operation can generally be automated. Further, in some embodiments, WAN interface 1910 can connect multiple server systems 1900 to each other, providing scalable systems capable of managing high volumes of activity. Other techniques for managing server systems and server farms (collections of server systems that cooperate) can be used, including dynamic resource allocation and reallocation.

Server system 1900 can interact with various user-owned or user-operated devices via a wide-area network such as the Internet. An example of a user-operated device is shown in FIG. 19 as client computing system 1914. Client computing system 1914 can be implemented, for example, as a consumer device such as a smartphone, other mobile phone, tablet computer, wearable computing device (e.g., smart watch, eyeglasses), desktop computer, laptop computer, and so on.

For example, client computing system 1914 can communicate via WAN interface 1910. Client computing system 1914 can include computer components such as processing unit(s) 1916, storage device 1918, network interface 1920, user input device 1922, and user output device 1924. Client computing system 1914 can be a computing device implemented in a variety of form factors, such as a desktop computer, laptop computer, tablet computer, smartphone, other mobile computing device, wearable computing device, or the like.

Processor 1916 and storage device 1918 can be similar to processing unit(s) 1904 and local storage 1906 described above. Suitable devices can be selected based on the demands to be placed on client computing system 1914; for example, client computing system 1914 can be implemented as a “thin” client with limited processing capability or as a high-powered computing device. Client computing system 1914 can be provisioned with program code executable by processing unit(s) 1916 to enable various interactions with server system 1900.

Network interface 1920 can provide a connection to the network 1926, such as a wide area network (e.g., the Internet) to which WAN interface 1910 of server system 1900 is also connected. In various embodiments, network interface 1920 can include a wired interface (e.g., Ethernet) and/or a wireless interface implementing various RF data communication standards such as Wi-Fi, Bluetooth, or cellular data network standards (e.g., 3G, 4G, LTE, etc.).

User input device 1922 can include any device (or devices) via which a user can provide signals to client computing system 1914; client computing system 1914 can interpret the signals as indicative of particular user requests or information. In various embodiments, user input device 1922 can include any or all of a keyboard, touch pad, touch screen, mouse or other pointing device, scroll wheel, click wheel, dial, button, switch, keypad, microphone, and so on.

User output device 1924 can include any device via which client computing system 1914 can provide information to a user. For example, user output device 1924 can include display-to-display images generated by or delivered to client computing system 1914. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). Some embodiments can include a device such as a touchscreen that function as both input and output device. In some embodiments, other user output devices 1924 can be provided in addition to or instead of a display. Examples include indicator lights, speakers, tactile “display” devices, printers, and so on.

Some embodiments include electronic components, such as microprocessors, storage and memory that store computer program instructions in a computer readable storage medium. Many of the features described in this specification can be implemented as processes that are specified as a set of program instructions encoded on a computer readable storage medium. When these program instructions are executed by one or more processing units, they cause the processing unit(s) to perform various operations indicated in the program instructions. Examples of program instructions or computer code include machine code, such as is produced by a compiler, and files including higher-level code that are executed by a computer, an electronic component, or a microprocessor using an interpreter. Through suitable programming, processing unit(s) 1904 and 1916 can provide various functionality for server system 1900 and client computing system 1914, including any of the functionality described herein as being performed by a server or client, or other functionality.

It will be appreciated that server system 1900 and client computing system 1914 are illustrative and that variations and modifications are possible. Computer systems used in connection with embodiments of the present disclosure can have other capabilities not specifically described here. Further, while server system 1900 and client computing system 1914 are described with reference to particular blocks, it is to be understood that these blocks are defined for convenience of description and are not intended to imply a particular physical arrangement of component parts. For instance, different blocks can be but need not be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present disclosure can be realized in a variety of apparatus including electronic devices implemented using any combination of circuitry and software.

While the disclosure has been described with respect to specific embodiments, one skilled in the art will recognize that numerous modifications are possible. Embodiments of the disclosure can be realized using a variety of computer systems and communication technologies including but not limited to specific examples described herein. Embodiments of the present disclosure can be realized using any combination of dedicated components and/or programmable processors and/or other programmable devices. The various processes described herein can be implemented on the same processor or different processors in any combination. Where components are described as being configured to perform certain operations, such configuration can be accomplished; e.g., by designing electronic circuits to perform the operation, by programming programmable electronic circuits (such as microprocessors) to perform the operation, or any combination thereof. Further, while the embodiments described above may make reference to specific hardware and software components, those skilled in the art will appreciate that different combinations of hardware and/or software components may also be used and that particular operations described as being implemented in hardware might also be implemented in software or vice versa.

Computer programs incorporating various features of the present disclosure may be encoded and stored on various computer readable storage media; suitable media include magnetic disk or tape, optical storage media such as compact disk (CD) or digital versatile disk (DVD), flash memory, and other non-transitory media. Computer readable media encoded with the program code may be packaged with a compatible electronic device, or the program code may be provided separately from electronic devices (e.g., via Internet download or as a separately packaged computer-readable storage medium).

Thus, although the disclosure has been described with respect to specific embodiments, it will be appreciated that the disclosure is intended to cover all modifications and equivalents within the scope of the following claims.

What is claimed is:

1. A method of configuring finite state machines (FSMs) for applications, comprising:
identifying, by at least one server, a configuration file for an application, the configuration file including human-readable instructions defining a plurality of FSMs for a corresponding plurality of routines to address a condition of a user, each of the plurality of FSMs identifying:
(i) a plurality of states including at least a first state and a second state, each of which specifies an output to provide via the application, and
(ii) a plurality of transitions, each of which specifies an event to be detected via the application to transition from the first state to the second state, the event corresponding to a user action to be performed via the application for the respective routine;
generating, by the at least one server, using the human-readable instructions of the configuration file, an intermediary instructions defining the plurality of FSMs; and
providing, by the at least one server, the intermediary instructions generated from the configuration file to the application to generate machine-readable instructions defining the plurality of FSMs to be selectively invoked by the application.

2. The method of claim 1, wherein each transition of the plurality of transitions in at least one FSM of the plurality of FSMs specifies the event to be detected via a user interface element of the application, the event corresponding to the user action to be performed for the respective routine.

3. The method of claim 1, wherein at least one transition of the plurality of transition in a first FSM of the plurality of FSMs specifies the event to invoke a second FSM of the plurality of FSMs defined by the human-readable instructions of the configuration file.

4. The method of claim 1, wherein at least one state of the plurality of states in at least one FSM of the plurality of FSMs identifies one or more user interface elements for presentation of the output via the application.

5. The method of claim 1, wherein identifying the configuration file further comprises receiving, from a computing device, a script including the human-readable instructions generated using a development application.

6. The method of claim 1, wherein providing the intermediary instructions further comprises sending, to a client device, the intermediary instructions to be loaded by the application installed on the client device.

7. The method of claim 1, further comprising receiving, by the at least one server, from the application on a client device, a record entry identifying the user action associated with the event detected via a user interface element of the application.

8. A system for configuring finite state machines (FSMs) for applications, comprising:
at least one server having one or more processors coupled with memory, configured to:
identify a configuration file for an application, the configuration file including human-readable instructions defining a plurality of FSMs for a corresponding plurality of routines, each of the plurality of FSMs identifying:
(i) a plurality of states including at least a first state and a second state, each of which specifies an output to provide via the application, and
(ii) a plurality of transitions, each of which specifies an event to be detected via the application to transition from the first state to the second state, the event corresponding to a user action to be performed via the application for the respective routine;
generate, using the human-readable instructions of the configuration file, an intermediary instructions defining the plurality of FSMs; and
provide the intermediary instructions generated from the configuration file to the application to generate machine-readable instructions defining the plurality of FSMs to be selectively invoked by the application.

9. The system of claim 8, wherein each transition of the plurality of transitions in at least one FSM of the plurality of FSMs specifies the event to be detected via a user interface element of the application, the event corresponding to the user action to be performed for the respective routine.

10. The system of claim 8, wherein at least one transition of the plurality of transition in a first FSM of the plurality of FSMs specifies the event to invoke a second FSM of the plurality of FSMs defined by the human-readable instructions of the configuration file.

11. The system of claim 8, wherein at least one state of the plurality of states in at least one FSM of the plurality of FSMs identifies one or more user interface elements for presentation of the output via the application.

12. The system of claim 8, wherein the at least one server is further configured to receive, from a computing device, a script including the human-readable instructions generated using a development application.

13. The system of claim 8, wherein the at least one server is further configured to send, to a client device, the intermediary instructions to be loaded by the application installed on the client device.

14. The system of claim 8, wherein the at least one server is further configured to send a content item for presentation via a user interface element of the application, responsive to the application invoking a first FSM of the plurality of FSMs upon detection of the event to transition from the first state to the second state.

15. The system of claim 8, wherein the at least one server is further configured to receive, from the application on a client device, a record entry identifying the user action associated with the event detected via a user interface element of the application.

16. A method of handling finite state machines (FSMs) on applications, comprising:
loading, by an application upon execution on a client device, machine-readable instructions defining a plurality of FSMs for a corresponding plurality of routines to address a condition of the user;
identifying, by the application, the plurality of FSMs defined by the machine-readable instructions, each FSM of the plurality of FSMs identifying:
(i) a respective first state of a plurality of states, each of the plurality of states specifying an output to provide via the application, and
(ii) a plurality of transitions from the respective current state, each transition of the plurality of transitions specifying a respective event to be detected via application to transition a corresponding FSM from the first state to a second state, the respective event corresponding a user action to be performed via the application for the respective routine;
detecting, by the application, the user action performed via the application corresponding to the respective event specified by at least one of the plurality of transitions identified in a FSM of the plurality of FSMs; and
updating, by the application, responsive to the detection of the user action, the FSM to from the respective first state to the second state to provide the output provided by the second state.

17. The method of claim 16, further comprising generating, by the application, the machine-readable instructions by compiling intermediary instructions defining the plurality of FSMs received from a server.

18. The method of claim 16, further comprising identifying, by the application, the machine-readable instructions for the corresponding plurality of routines to load based on the condition of the user to be addressed.

19. The method of claim 16, further comprising replacing, by the application, second machine-readable instructions with the machine-readable instructions, responsive to receiving an configuration update including the machine-readable instructions to address the condition of the user.

20. The method of claim 16, wherein detecting further comprises monitoring, using an event bus, an invocation of the FSM in response to the user action corresponding to the respective event specified by the at least one of the plurality of transitions of the respective current state.

21. The method of claim 16, wherein updating further comprises retrieving, from a server, a content item for presentation via a user interface element of the application in accordance with the output specified by the second state of the FSM.

22. The method of claim 16, wherein at least one transition of the plurality of transition in a first FSM of the plurality of FSMs specifies the event to invoke a second FSM of the plurality of FSMs defined by the machine-readable instructions of the configuration file.

23. A system for handling finite state machines (FSMs) on applications, comprising:
an application executable on a client device having one or more processors coupled with memory, the application configured to:
load, upon execution, machine-readable instructions defining a plurality of FSMs for a corresponding plurality of routines to address a condition of the user;
identify the plurality of FSMs defined by the machine-readable instructions, each FSM of the plurality of FSMs identifying:
(i) a respective first state of a plurality of states, each of the plurality of states specifying an output to provide via the application, and
(ii) a plurality of transitions from the respective current state, each transition of the plurality of transitions specifying a respective event to be detected via application to transition a corresponding FSM from the first state to a second state, the respective event corresponding a user action to be performed via the application for the respective routine;
detect the user action performed via the application corresponding to the respective event specified by at least one of the plurality of transitions identified in a FSM of the plurality of FSMs; and
update, responsive to the detection of the user action, the FSM to from the respective first state to the second state to provide the output provided by the second state.

24. The system of claim 23, wherein the application is further configured to generate the machine-readable instructions by compiling intermediary instructions defining the plurality of FSMs received from a server.

25. The system of claim 23, wherein the application is further configured to identify the machine-readable instructions for the corresponding plurality of routines to load based on the condition of the user to be addressed.

26. The system of claim 23, wherein the application is further configured to replace second machine-readable instructions with the machine-readable instructions, responsive to receiving an configuration update including the machine-readable instructions to address the condition of the user.

27. The system of claim 23, wherein the application is further configured to transmit, to the server, a record entry identifying the user action associated with the event detected via a user interface element of the application.

28. The system of claim 23, wherein the application is further configured to monitor, using an event bus, an invocation of the FSM in response to the user action corresponding to the respective event specified by the at least one of the plurality of transitions of the respective current state.

29. The system of claim 23, wherein the application is further configured to retrieve, from a server, a content item for presentation via a user interface element of the application in accordance with the output specified by the second state of the FSM.

30. The system of claim 23, wherein at least one transition of the plurality of transition in a first FSM of the plurality of FSMs specifies the event to invoke a second FSM of the plurality of FSMs defined by the machine-readable instructions of the configuration file.
